(19) United States
(12) Patent Application Publication
(10) Pub. No.: US 2024/0322222 A1
(43) Pub. Date: Sep. 26, 2024

(54) ELECTRODE, SECONDARY BATTERY, BATTERY PACK, AND VEHICLE

(71) Applicant: KABUSHIKI KAISHA TOSHIBA, Tokyo (JP)

(72) Inventors: Yuiko KOITABASHI, Yokohama (JP); Tetsuya SASAKAWA, Yokohama (JP); Hirofumi YASUMIISHI, Kawasaki (JP); Mitsuhiro OKI, Kawasaki (JP); Sayaka MORIMOTO, Kawasaki (JP)

(73) Assignee: KABUSHIKI KAISHA TOSHIBA, Tokyo (JP)

(21) Appl. No.: 18/485,357

(22) Filed: Oct. 12, 2023

(30) Foreign Application Priority Data
Mar. 20, 2023 (JP) 2023-044522

(51) Int. Cl. H01M 10/0562; B60L 7/10; H01M 50/204; H01M 50/574

(52) U.S. Cl. CPC H01M 10/0562; B60L 7/10; H01M 50/204; H01M 50/574; B60L 50/64; H01M 2220/20; H01M 2300/0068

(57) ABSTRACT

In general, according to one embodiment, an electrode is provided. The electrode includes an active material and a titanium-containing solid electrolyte. The active material includes a transition metal oxide. In an X-ray absorption fine structure spectrum of Ti—K absorption edge for the electrode in a discharged state, a first X-ray absorption amount I at a first incident X-ray energy satisfies 0.2≤I≤0.6. In an X-ray absorption fine structure spectrum of Ti—K absorption edge for anatase titanium dioxide, a second X-ray absorption amount at a second incident X-ray energy is equal to the first X-ray absorption amount I. The first incident X-ray energy is higher than the second incident X-ray energy.

### CROSS-REFERENCE TO RELATED APPLICATIONS

This application is based upon and claims the benefit of priority from Japanese Patent Application No. 2023-044522, filed Mar. 20, 2023, the entire contents of which are incorporated herein by reference.

### FIELD

Embodiments described herein relate generally to an electrode, a secondary battery, a battery pack, and a vehicle.

### BACKGROUND

In a nonaqueous electrolyte battery such as a lithium ion secondary battery, there is a problem that the discharge capacity of an electrode decreases with a charge-discharge cycle.

### BRIEF DESCRIPTION OF THE DRAWINGS

FIG. 1 is a cross-sectional view schematically illustrating an example of a secondary battery according to an embodiment.

FIG. 2 is an enlarged cross-sectional view of a section A of the secondary battery illustrated in FIG. 1.

FIG. 3 is a partially cut-out perspective view schematically illustrating another example of the secondary battery according to the embodiment.

FIG. 4 is an enlarged cross-sectional view of a section B of the secondary battery illustrated in FIG. 3.

FIG. 5 is a perspective view schematically illustrating an example of a battery module according to an embodiment.

FIG. 6 is an exploded perspective view schematically illustrating an example of a battery pack according to an embodiment.

FIG. 7 is a block diagram illustrating an example of an electric circuit of the battery pack illustrated in FIG. 6.

FIG. 8 is a partially see-through diagram schematically illustrating an example of a vehicle according to an embodiment.

FIG. 9 is a diagram schematically illustrating an example of a control system related to an electric system in the vehicle according to the embodiment.

FIG. 10 is an X-ray absorption fine structure spectrum for an example of a titanium-containing solid electrolyte.

FIG. 11 is an X-ray absorption fine structure spectrum for another example of the titanium-containing solid electrolyte.

### DETAILED DESCRIPTION

In general, according to one embodiment, an electrode is provided. The electrode includes an active material and a titanium-containing solid electrolyte. The active material includes a transition metal oxide.

In an X-ray absorption fine structure spectrum of Ti—K absorption edge for an electrode in a discharged state, a first X-ray absorption amount I at a first incident X-ray energy in a range of 4930 eV or more and 5000 eV or less satisfies 0.2≤I≤0.6, where an X-ray absorption amount at an incident X-ray energy of 5500 eV is 1.

In an X-ray absorption fine structure spectrum of Ti—K absorption edge for anatase titanium dioxide, a second X-ray absorption amount at a second incident X-ray energy in a range of 4930 eV or more and 5000 eV or less is equal to the first X-ray absorption amount I, where an X-ray absorption amount at an incident X-ray energy of 5500 eV is 1. The first incident X-ray energy is higher than the second incident X-ray energy.

According to another embodiment, a secondary battery including the electrode of the embodiment is provided.

According to another embodiment, a battery pack including the secondary battery of the embodiment is provided.

According to another embodiment, a vehicle including the battery pack of the embodiment is provided.

Hereinafter, embodiments will be described with reference to the drawings as appropriate. The same reference signs are applied to common components throughout the embodiments and overlapped explanations are thereby omitted. Each drawing is a schematic view for encouraging explanations of the embodiment and understanding thereof, and thus there are some details in which a shape, a size and a ratio are different from those in an actual device; they can however be appropriately design-changed, taking into account the following explanations and known technology.

### First Embodiment

One of the factors that reduce the discharge capacity of the electrode with the charge-discharge cycle is deterioration in active material in the electrode. Deterioration in active material may occur, for example, upon contact, with the active material, of hydrofluoric acid generated by a side reaction.

As a result of further research based on this result, the electrode according to the first embodiment has been realized.

The electrode according to the first embodiment includes an active material and a titanium-containing solid electrolyte. The active material includes a transition metal oxide.

In an X-ray absorption fine structure spectrum of Ti—K absorption edge for an electrode in a discharged state, a first X-ray absorption amount I at a first incident X-ray energy in a range of 4930 eV or more and 5000 eV or less satisfies 0.2≤I≤0.6, where an X-ray absorption amount at an incident X-ray energy of 5500 eV is 1.

In an X-ray absorption fine structure spectrum of Ti—K absorption edge for anatase titanium dioxide, a second X-ray absorption amount at a second incident X-ray energy in a range of 4930 eV or more and 5000 eV or less is equal to the first X-ray absorption amount I, where an X-ray absorption amount at an incident X-ray energy of 5500 eV is 1. The first incident X-ray energy is higher than the second incident X-ray energy.

The titanium-containing solid electrolyte can trap hydrofluoric acid. Therefore, for example, it is possible to suppress contact of hydrofluoric acid generated by a side reaction with the active material. Therefore, deterioration in active material can be suppressed.

The first X-ray absorption amount is a relative value on the condition that an X-ray absorption amount at an incident X-ray energy of 5500 eV is 1 in an X-ray absorption fine structure (XAFS) spectrum for an electrode in a discharged state. The second X-ray absorption amount is a relative value on the condition that an X-ray absorption amount at an incident X-ray energy of 5500 eV is 1 in an XAFS spectrum for anatase titanium dioxide.

In the XAFS spectrum at the Ti—K absorption edge, the incident X-ray energy range of 4930 eV or more and 5000 eV or less is an X-ray absorption near edge structure (XANES) region. In the XANES region, the fact that the first X-ray absorption amount at the first incident X-ray energy is equal to the second X-ray absorption amount at the second incident X-ray energy, and that the first incident X-ray energy is higher than the second incident X-ray energy means that the electrode in the discharged state includes a material having a valence larger than that of the anatase titanium dioxide. The valence of the anatase titanium dioxide is, for example, tetravalent.

The first incident X-ray energy may be higher than the second incident X-ray energy at all points where the first X-ray absorption amount at the first incident X-ray energy is equal to the second X-ray absorption amount at the second incident X-ray energy in the XANES region. The first incident X-ray energy may be higher than the second incident X-ray energy at at least one point where the first X-ray absorption amount at the first incident X-ray energy is equal to the second X-ray absorption amount at the second incident X-ray energy in the XANES region.

Examples of the material having a valence higher than that of the anatase titanium dioxide may include a titanium-containing solid electrolyte. The titanium-containing solid electrolyte having a valence higher than that of the anatase titanium dioxide has a large surface area as will be described later. Therefore, hydrofluoric acid can be efficiently trapped. Thus, the cycle performance can be improved.

Hereinafter, the electrode according to the embodiment will be described in detail with reference to the drawings.

The electrode can be, for example, for a nonaqueous electrolyte battery. The nonaqueous electrolyte battery can be, for example, a nonaqueous electrolyte battery using an alkali metal ion as a carrier ion. For example, the battery may be a lithium battery (lithium ion battery). The electrode can be, for example, for a secondary battery.

In a manufacturing process of the nonaqueous electrolyte battery, water is likely to be mixed as an inevitable impurity. In a case where a nonaqueous electrolyte containing a fluorine atom is used as a nonaqueous electrolyte to be combined with the electrode, a side reaction occurs between water and the nonaqueous electrolyte, so that hydrofluoric acid (hydrogen fluoride, HF) can be generated as a decomposition product of the nonaqueous electrolyte. Details of the nonaqueous electrolyte will be described later.

Upon contact of hydrofluoric acid with the material included in the electrode, a transition metal may be eluted, for example. The eluted transition metal may be deposited, for example, on the electrode. In addition, the hydrofluoric acid can react with an electrolyte to form lithium fluoride in a case where the electrode is combined with the electrolyte. The lithium fluoride may be deposited, for example, on the electrode. These materials deposited on the electrode may cause an increase in resistance.

The electrode includes a titanium-containing solid electrolyte. Therefore, elution of a transition metal and formation of lithium fluoride can be suppressed. Therefore, the output performance of the electrode can be improved.

The titanium-containing solid electrolyte is a solid substance having Li ion conductivity. Having Li ion conductivity, as referred to herein, indicates exhibiting a lithium ion conductivity of 1×10⁻⁶ S/cm or more at 25° C. The titanium-containing solid electrolyte can be, for example, particulate. In titanium-containing solid electrolyte particles, at least a part of the surfaces thereof may be amorphous.

When the titanium-containing solid electrolyte is completely amorphous, i.e., is an amorphous solid electrolyte, side reactions with a nonaqueous electrolyte may increase when it is combined with the nonaqueous electrolyte. Therefore, the titanium-containing solid electrolyte is preferably at least partially crystalline.

The titanium-containing solid electrolyte preferably includes a titanium-containing composite oxide. The titanium-containing composite oxide may be, for example, a titanium-containing lithium phosphate composite oxide. Examples of the titanium-containing lithium phosphate composite oxide include a lithium phosphate solid electrolyte having a sodium (Na) super ionic conductor (NASICON) structure and represented by a general formula Li₁₊ₓMα₂(PO₄)₃. Mα in the above general formula includes titanium (Ti). Mα may be composed only of titanium (Ti), or may include Ti and, for example, one or more selected from the group consisting of germanium (Ge), strontium (Sr), zirconium (Zr), tin (Sn), aluminum (Al), and calcium (Ca). The subscript x is in a range of 0≤x≤2.

Specific examples of the lithium phosphate solid electrolyte having the NASICON structure can include an LATP compound represented by Li₁₊ₓAlₓTi₂₋ₓ(PO₄)₃ where 0.1≤x≤0.5; a compound including Ti in the composition among compounds represented by Li₁₊ₓAl_{y}Mβ_{2-y}(PO₄)₃ where Mβ is one or more selected from the group consisting of Ti, Ge, Sr, Zr, Sn, and Ca, 0≤x≤1, and 0≤y≤1; and a compound including Ti in the composition among compounds represented by Li_{1+x+y}AlₓMγ₂₋ₓSi_{y}P_{3-y}O₁₂ where Mγ is one or more selected from the group consisting of Ti and Ge, 0≤x≤2, and 0≤y≤3.

The type of the titanium-containing solid electrolyte can be one or two or more.

A content of the lithium phosphate composite oxide in the titanium-containing solid electrolyte is preferably more than 98 mass %. In a case where the titanium-containing solid electrolyte includes the lithium phosphate composite oxide in an amount of more than 98 mass %, the hydrofluoric acid trapping effect can be easily obtained, so that the cycle performance and the output performance can be improved. A proportion of the lithium phosphate composite oxide in the titanium-containing solid electrolyte can be 100 mass %.

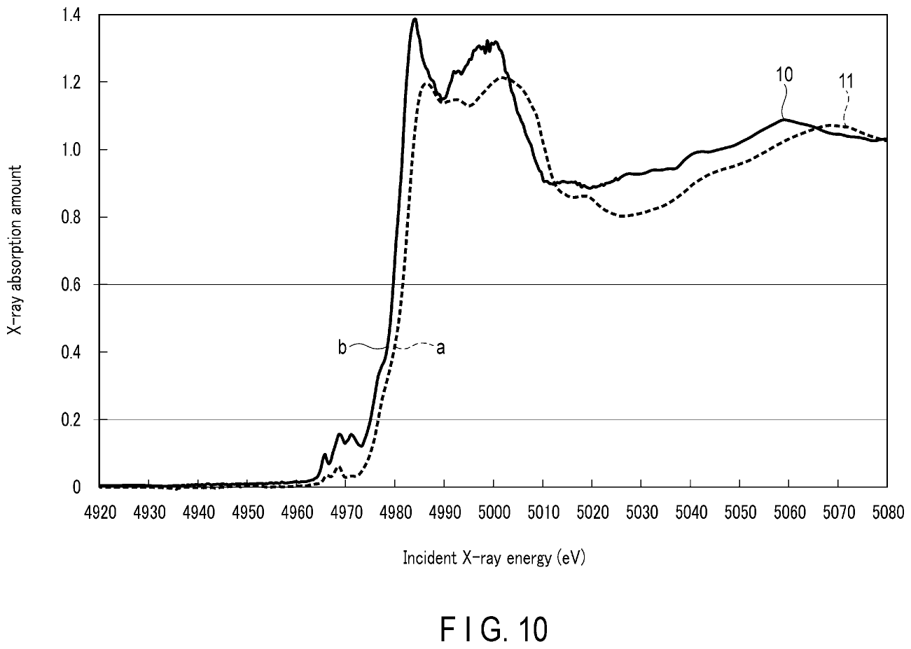

FIG. 10 is an X-ray absorption fine structure spectrum illustrating an example of the titanium-containing solid electrolyte that can be included in the electrode of the embodiment. The horizontal axis represents the incident X-ray energy, and the vertical axis represents a relative value of the X-ray absorption amount. The relative value of the X-ray absorption amount is a value of the X-ray absorption amount normalized on the condition that the X-ray absorption amount at an incident X-ray energy of 5500 eV is 1. A spectrum 10 is an XAFS spectrum of the anatase titanium dioxide. A spectrum 11 is an XAFS spectrum according to an example of the titanium-containing solid electrolyte. The spectra 10 and 11 are normalized on the condition that the X-ray absorption amount at an incident X-ray energy in each spectrum of 5500 eV is 1.

In the spectrum 11, a certain incident X-ray energy in the range where the incident X-ray energy is 4930 eV or more and 5000 eV or less is defined as a first incident X-ray energy a, and an X-ray absorption amount for the first incident X-ray energy a is defined as a first X-ray absorption amount. The first X-ray absorption amount I is set so as to satisfy 0.2≤I≤0.6.

Further, in the spectrum 10, a certain incident X-ray energy in the range where the incident X-ray energy is 4930 eV or more and 5000 eV or less is defined as a second incident X-ray energy b, and an X-ray absorption amount for the second incident X-ray energy b is defined as a second X-ray absorption amount. The second X-ray absorption amount is set so as to be equal to the first X-ray absorption amount I.

Under the above-described setting, a point a where the first incident X-ray energy is higher than the second incident X-ray energy can be taken on the spectrum 11 of the titanium-containing solid electrolyte. Therefore, in the electrode including the titanium-containing solid electrolyte related to the spectrum 11, the first incident X-ray energy may be higher than the second incident X-ray energy. That is, the XAFS spectrum of the electrode can be shifted to a high energy side as compared with the XAFS spectrum of the anatase titanium dioxide.

The titanium-containing solid electrolyte related to the example shown in the spectrum 11 can be fabricated, for example, by surface-treating the titanium-containing solid electrolyte as follows. As the titanium-containing solid electrolyte to be subjected to the surface treatment, a crystalline one can be used. The surface treatment can be performed, for example, by the following acid treatment.

The acid treatment can be performed, for example, by charging a titanium-containing solid electrolyte into an aqueous hydrofluoric acid solution and stirring the solution. A concentration of the aqueous hydrofluoric acid solution is preferably 1 mass % or more and 5 mass % or less. A stirring temperature is preferably in a range of 25° C. or higher and 45° C. or lower. A stirring time is preferably in a range of 1 hour or longer and 80 hours or shorter.

The surfaces of the titanium-containing solid electrolyte particles can be amorphized by the acid treatment. If the concentration of the aqueous hydrofluoric acid solution is 1 mass % or more, amorphization of the surfaces can be efficiently advanced. If the concentration of the aqueous hydrofluoric acid solution is 5 mass % or less, excessive advance of amorphization can be suppressed. Therefore, internal crystal structures of the titanium-containing solid electrolyte particles are easily maintained. Therefore, titanium-containing solid electrolyte particles in which the particle surfaces are amorphous and at least a part of the particles other than the particle surfaces is crystalline are easily obtained. Such titanium-containing solid electrolyte particles are preferable because their amorphized state is stable.

The acid treatment can also be performed by immersing the titanium-containing solid electrolyte in a liquid obtained by adding water to a liquid electrolyte containing a fluorine atom. Details of the liquid electrolyte will be described later. Examples of the liquid electrolyte containing a fluorine atom include liquid electrolytes including, as electrolyte salts, lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂). The type of the electrolyte salt that is included in the liquid electrolyte can be one or two or more. A concentration of water in the liquid is preferably 0.1 mass % or more and 1 mass % or less. The concentration of water in the liquid is set to 0.1 mass % or more, so that the acid treatment can be efficiently performed. The concentration of water in the liquid is 1 mass % or less, so that excessive advance of amorphization can be suppressed.

The surface treatment may increase the valence of the titanium-containing solid electrolyte. Therefore, in the electrode including the surface-treated titanium-containing solid electrolyte, the first incident X-ray energy may be higher than the second incident X-ray energy.

In addition, the surface treatment may increase the surface area of the titanium-containing solid electrolyte particles. This is due to the amorphization of the particle surfaces by the surface treatment. The titanium-containing solid electrolyte particles having an amorphous surface can efficiently trap hydrofluoric acid.

This is considered to be due to the following mechanism. The titanium-containing solid electrolyte has a functional group capable of trapping hydrofluoric acid on the surface. The amorphization of the surface of the titanium-containing solid electrolyte particles by the surface treatment as described above increases the surface area of the particles. Therefore, due to an increase in functional group capable of trapping hydrofluoric acid, the amount of hydrofluoric acid that can be trapped by the titanium-containing solid electrolyte particles increases.

Therefore, the electrode in which the first incident X-ray energy is higher than the second incident X-ray energy has a high hydrofluoric acid trapping ability of the titanium-containing solid electrolyte. Therefore, the cycle performance and the output performance can be improved.

A difference (shift amount) between the first incident X-ray energy and the second incident X-ray energy is preferably in a range of 1 eV or more and 4 eV or less, and more preferably in a range of 3 eV or more and 3.5 eV or less.

A large difference between the first incident X-ray energy and the second incident X-ray energy tends to result in many amorphized portions in the titanium-containing solid electrolyte.

In a case where the difference between the first incident X-ray energy and the second incident X-ray energy is excessively large, even the inside of the titanium-containing solid electrolyte may be amorphized. In a case where even the inside of the titanium-containing solid electrolyte is amorphized, the hydrofluoric acid trapping ability of the titanium-containing solid electrolyte may be lowered. The difference between the first incident X-ray energy and the second incident X-ray energy is preferably 4.0 eV or less, and more preferably in a range of 3.5 eV or less.

In a case where the difference between the first incident X-ray energy and the second incident X-ray energy is excessively small, the effect for improving the hydrofluoric acid trapping ability may be reduced because the surface of the titanium-containing solid electrolyte is at least partially amorphous. The difference between the first incident X-ray energy and the second incident X-ray energy is preferably 1.0 eV or more, and more preferably 3.0 eV or more.

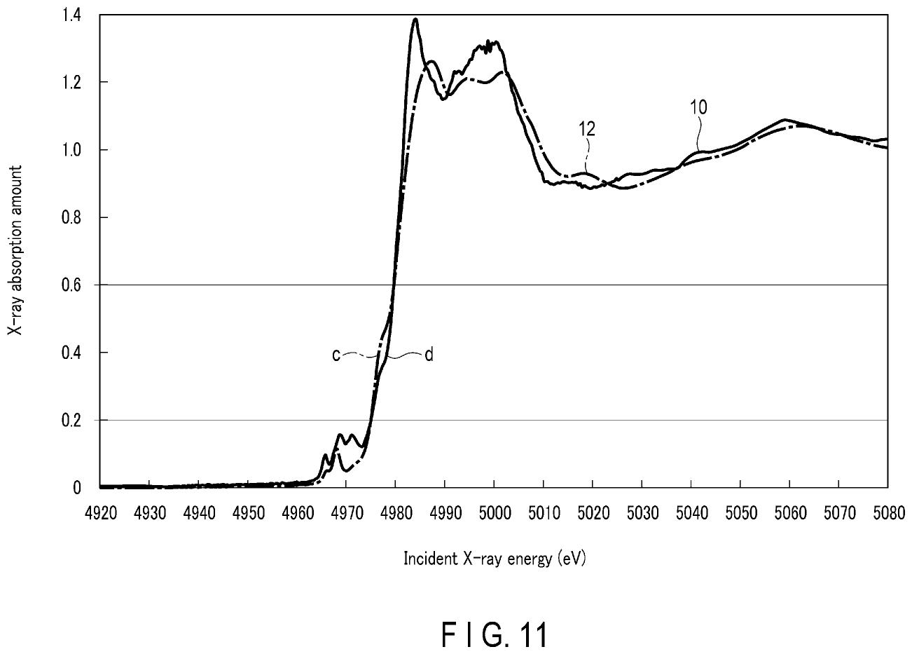

FIG. 11 is an X-ray absorption fine structure spectrum illustrating another example of the titanium-containing solid electrolyte. The horizontal axis represents the incident X-ray energy, and the vertical axis represents a relative value of the X-ray absorption amount. A spectrum 12 is an XAFS spectrum according to another example of the titanium-containing solid electrolyte. Another example of the titanium-containing solid electrolyte is the same as the titanium-containing solid electrolyte related to the spectrum 11 described above, except that the surface treatment described above is not performed.

The spectra 10 and 12 are normalized on the condition that the X-ray absorption amount at the incident X-ray energy in each spectrum of 5500 eV is 1.

In the spectrum 12, a certain incident X-ray energy in the range where the incident X-ray energy is 4930 eV or more and 5000 eV or less is defined as a first incident X-ray energy c, and an X-ray absorption amount for the first incident X-ray energy c is defined as a first X-ray absorption amount. The first X-ray absorption amount I is set so as to satisfy 0.2≤I≤0.6.

Further, in the spectrum 10, a certain incident X-ray energy in the range where the incident X-ray energy is 4930 eV or more and 5000 eV or less is defined as a second incident X-ray energy d, and an X-ray absorption amount for the second incident X-ray energy d is defined as a second X-ray absorption amount. The second X-ray absorption amount is set so as to be equal to the first X-ray absorption amount I.

There is no point c where the first incident X-ray energy is higher than the second incident X-ray energy on the spectrum 12. Therefore, in a case where the electrode includes the titanium-containing solid electrolyte related to the spectrum 12, the first incident X-ray energy cannot be higher than the second incident X-ray energy.

The X-ray absorption fine structure spectrum can be acquired as follows.

### <X-Ray Absorption Fine Structure Analysis>

### (Provision of Measurement Sample)

In a case where a substance such as anatase titanium dioxide or a titanium-containing solid electrolyte is analyzed, a powder of the substance to be analyzed is subjected to X-ray absorption fine structure (XAFS) analysis. As the anatase titanium dioxide, a commercially available anatase titanium dioxide powder having a purity of 99.5% or more can be used.

In a case where an electrode is analyzed, an electrochemical measurement cell is fabricated using a measurement electrode, and then discharged to bring the electrode into a discharged state, as will be described below.

In a case where the electrode to be measured is incorporated in a battery, the electrode to be measured is extracted from the battery, washed and dried as follows, and then used in the fabrication of an electrochemical measurement cell. First, a battery incorporating an electrode is disassembled in a glove box filled with argon. The electrode to be measured is extracted from the disassembled battery. This electrode is washed with an appropriate solvent. As the solvent used in the washing, for example, methyl ethyl carbonate or the like can be used. The washed electrode is vacuum-dried. Thus, a measurement electrode is obtained.

Next, an electrochemical measurement cell is fabricated using the measurement electrode. The electrochemical measurement cell can be fabricated using the measurement electrode, a metal lithium foil as a counter electrode, and a nonaqueous electrolyte. As the nonaqueous electrolyte, a nonaqueous electrolyte prepared by dissolving lithium hexafluorophosphate (LiPF₆) at a concentration of 1 M in a mixed solvent of ethylene carbonate and diethyl carbonate (volume ratio 1:1) is used.

The fabricated electrochemical measurement cell is discharged at 0.05 C, and adjustment is made so that the potential of the measurement electrode is 3.0 V based on metal lithium. The electrode is brought into a discharged state in this manner.

The electrode in the discharged state is subjected to X-ray absorption fine structure (XAFS) analysis.

### (XAFS Analysis)

The XAFS analysis can be performed using a synchrotron radiation facility such as a large synchrotron radiation facility SPring-8.

Measurement conditions for XAFS at Ti—K edge are as follows.
Spectrometer: Si (111) bicrystal spectrometer
Higher-order light removal: Rh-coated mirror 6 mrad
Incident X-ray size: 1 mm in length×1 mm in width
Measurement method: transmission method
Detector: ion chamber

Under the above conditions, incident light intensity I0 and transmitted light intensity I1 in a range where the incident X-ray energy is 4600 eV or more and 6000 eV or less are measured. An X-ray absorption amount for each incident X-ray energy is determined from I0 and I1 by the following equation. In the equation, μt represents the X-ray absorption amount.

$$\\ \begin{matrix}μ t = - ln ( I 1 / I 0 ) & Math 1\end{matrix}$$

By plotting the incident X-ray energy on the x-axis and the X-ray absorption amount (μt) on the y-axis, an XAFS spectrum can be obtained. Using the Victoreen equation representing an intensity change due to X-ray scattering, data preceding an absorption edge are approximated by a least squares method, and background is subtracted. Thus, the background is removed from the XAFS spectrum.

In the XAFS spectrum from which the background has been removed, the X-ray absorption amount is normalized on the condition that an X-ray absorption amount at an incident X-ray energy of 5500 eV is 1. Thus, a normalized spectrum can be obtained.

Based on XAFS analysis after the electrode is brought into a discharged state, for example, Ti atoms that can be included in the active material in the electrode can be tetravalent. Therefore, the valence of Ti can be equalized between the anatase titanium dioxide as a comparison criterion and the electrode to be measured.

The electrode according to the embodiment will be described in more detail.

The electrode can include a current collector and an active material-containing layer. The active material-containing layer can be formed on one side or both sides of the current collector. The active material-containing layer can include an active material, a titanium-containing solid electrolyte, and optionally an electro-conductive agent and a binder. The active material includes a transition metal oxide.

The active material-containing layer may include one type of transition metal oxide singly as the active material, or, alternatively, may include two or more types of transition metal oxides in combination. The active material may include a transition metal oxide and another compound in combination.

The form of the active material is not particularly limited. The active material can take the form of, for example, primary particles, and also can take the form of secondary particles obtained by aggregation of primary particles. The active material may be a mixture of primary particles and secondary particles. The active material may have a granular or massive form with a larger dimension than the size of so-called particles.

The active material can take, for example, a powdery form of a mixture containing primary particles and secondary particles. An average particle size of an active material powder is more preferably in a range of 0.1 μm or more and 30 μm or less. The average particle size of the active material powder is preferably in a range of 0.5 μm or more and 30 μm or less.

For the measurement of the average particle size, a laser diffraction scattering method can be used. A particle size at which a cumulative volume distribution is 50% in a particle size distribution chart obtained by the laser diffraction scattering method is defined as an average particle size (D50).

A specific surface area of the active material is not particularly limited, and may be in a range of 0.1 m²/g or more and less than 200 m²/g. The specific surface area is preferably 5 m²/g or more and less than 200 m²/g.

If the specific surface area is 5 m²/g or more, a contact area with an electrolyte can be secured, and thus good discharge rate characteristics can be easily obtained, and the charging time can be shortened. On the other hand, if the specific surface area is less than 200 m²/g, the reactivity with the electrolyte does not become too high, and thus life characteristics can be improved. In addition, coatability of the slurry containing the active material can be improved. The slurry will be described later.

Here, for the measurement of the specific surface area, a method is used wherein molecules, for which an occupied area in adsorption is known, are adsorbed onto surfaces of powder particles at a temperature of liquid nitrogen, and a specific surface area of a sample is determined from an amount of adsorbed molecules. The BET (Brunauer, Emmett, Teller) method based on low-temperature and low-humidity physical adsorption of an inert gas is most often used, and is the most famous theory as a method for calculating the specific surface area, which is an extension of the Langmuir theory, as a monolayer adsorption theory, to multilayer adsorption. The thus obtained specific surface area is referred to as BET specific surface area.

Hereinafter, a case where the electrode is used as a negative electrode and a case where the electrode is used as a positive electrode will be described separately.

### 1) Negative Electrode

First, the case where the electrode according to the embodiment is used as the negative electrode will be described.

For example, in a case where the electrode according to the first embodiment is used as the negative electrode, examples of the transition metal oxide included in the active material include lithium titanate having a ramsdellite structure (e.g., Li_{2+y}Ti₃O₇, 0≤y≤3), lithium titanate having a spinel structure (e.g., Li₄₊ₓTi₅O₁₂, 0≤x≤3), titanium dioxide (TiO₂), anatase titanium dioxide, rutile titanium dioxide, niobium pentoxide (Nb₂O₃), hollandite titanium composite oxide, orthorhombic titanium-containing composite oxide, and monoclinic niobium titanium oxide.

Examples of the orthorhombic titanium-containing composite oxide as described above include a compound represented by Li₂₊ₐM^{I}_{2-b}Ti_{6-c}M^{II}_{d}O_{14+σ}. Here, M^{I} is at least one selected from the group consisting of Sr, Ba, Ca, Mg, Na, Cs, Rb and K. M^{II} is at least one selected from the group consisting of Zr, Sn, V, Nb, Ta, Mo, W, Y, Fe, Co, Cr, Mn, Ni and Al. The respective subscripts in the composition formula are as follows: 0≤a≤6, 0≤b<2, 0≤c<6, 0≤d<6, and −0.5≤σ≤0.5. A specific example of the orthorhombic titanium-containing composite oxide is Li₂₊ₐNa₂Ti₆O₁₄ (0≤a≤6).

An example of the monoclinic niobium titanium oxide is a compound represented by LiₓTi_{1-y}M1_{y}Nb_{2-z}M_{2z}O_{7+δ}. Here, M1 is at least one selected from the group consisting of Zr, Si, and Sn. M2 is at least one selected from the group consisting of V, Ta, and Bi. The respective subscripts in the composition formula are as follows: 0≤x≤5, 0≤y<1, 0≤z<2, and −0.3≤δ≤0.3. A specific example of the monoclinic niobium titanium oxide is LiₓNb₂TiO₇ (0≤x≤5).

Another example of the monoclinic niobium titanium oxide is a compound represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formula are as follows: 0≤x≤5, 0≤y<1, 0≤z<2, and −0.3≤δ≤0.3.

The electro-conductive agent is blended to enhance current collection performance and to suppress contact resistance between the active material and the current collector. Examples of the electro-conductive agent include carbonaceous substances such as vapor grown carbon fiber (VGCF), carbon blacks such as acetylene black, graphite, carbon nanotubes, and carbon nanofibers. One of these may be used as the electro-conductive agent, or two or more may be used in combination as the electro-conductive agent. Alternatively, instead of using the electro-conductive agent, a carbon coat or an electronically conductive inorganic material coat may be applied to the surfaces of the active material particles.

The binder is blended to fill gaps among the dispersed active material and also to bind the active material with the current collector. Examples of the binder include polytetrafluoro ethylene (PTFE), polyvinylidene fluoride (PVdF), fluorine rubber, styrene-butadiene rubber (SBR), polyacrylic acid compounds, imide compounds, carboxymethyl cellulose (CMC), and salts of CMC. One of these may be used as the binder, or alternatively, two or more may be used in combination as the binder.

Blending proportions of the active material, titanium-containing solid electrolyte, electro-conductive agent and binder in the active material-containing layer may be appropriately changed according to the use of the electrode. For example, in a case of using the electrode as a negative electrode of a secondary battery, the active material (negative electrode active material) is preferably blended in a proportion of 68 mass % or more and 96 mass % or less. The titanium-containing solid electrolyte is preferably blended in a proportion of 0.05 mass % or more and 30 mass % or less. The electro-conductive agent is preferably blended in a proportion of 2 mass % or more and 30 mass % or less. The binder is preferably blended in a proportion of 2 mass % or more and 30 mass % or less.

A total blending proportion of the negative electrode active material, titanium-containing solid electrolyte, electro-conductive agent and binder can be 100 mass %. At this time, the blending proportion of each material may be an arbitrary value regardless of the above-described proportions. For example, in a case where the negative electrode active material is blended in the above proportion, the total blending proportion of the negative electrode active material, titanium-containing solid electrolyte, electro-conductive agent and binder can be adjusted to 100 mass % by setting the blending proportions of the titanium-containing solid electrolyte, electro-conductive agent and binder to arbitrary values. The blending proportion of the electro-conductive agent or the binder may be 0 mass %.

It is particularly preferable that the blending proportions of the negative electrode active material, titanium-containing solid electrolyte, electro-conductive agent and binder all fall within the above numerical ranges, and that the total blending proportion thereof is 100 mass %.

By setting an amount of the titanium-containing solid electrolyte to 0.05 mass % or more, the output performance can be further improved. An amount of the electro-conductive agent is set to 2 mass % or more, so that the current collection performance of the active material-containing layer can be improved. An amount of binder is set to 2 mass % or more, so that binding between the active material-containing layer and the current collector is sufficient, whereby excellent cycling performances can be expected. On the other hand, an amount of each of the electro-conductive agent and binder is preferably 30 mass % or less, in view of increasing the capacity. In order to improve an energy density, the titanium-containing solid electrolyte is preferably 30 mass % or less.

There may be used for the current collector, a material which is electrochemically stable at a potential at which lithium (Li) is inserted into and extracted from the active material. For example, in a case where the active material is used as the negative electrode active material, the current collector is preferably made of copper, nickel, stainless steel, aluminum, or an aluminum alloy including one or more elements selected from the group consisting of Mg, Ti, Zn, Mn, Fe, Cu, and Si. The current collector may be, for example, a metal foil including the above material. A thickness of the current collector is preferably 5 μm or more and 20 μm or less. The current collector having such a thickness can achieve a balance between strength and weight reduction of the electrode.

The current collector can include a portion where no negative electrode active material-containing layer is formed on a surface thereof. This portion can serve as a negative electrode current-collecting tab.

The negative electrode can be fabricated, for example, by the following method. First, an active material, a titanium-containing solid electrolyte, an electro-conductive agent, and a binder are suspended in a solvent to prepare a slurry. The slurry is applied onto one side or both sides of a current collector. Then, the applied slurry is dried to obtain a stack of an active material-containing layer and the current collector. Then, the stack is subjected to pressing. The negative electrode is fabricated in this manner.

In the fabrication of the negative electrode, for example, water can be used as the solvent for the slurry.

Alternatively, the negative electrode may be fabricated by the following method. First, an active material, a titanium-containing solid electrolyte, an electro-conductive agent and a binder are mixed to obtain a mixture. Next, the mixture is formed into pellets. Then, the negative electrode can be obtained by disposing the pellets onto the current collector.

### 2) Positive Electrode

Next, the case where the electrode according to the embodiment is used as the positive electrode will be described.

For example, in a case where the electrode according to the first embodiment is used as the positive electrode, for example, an oxide or a sulfide can be used as an example of the active material. Examples of the oxide and sulfide include compounds capable of having Li and Li ions be inserted and extracted. The oxide may be a transition metal oxide. The transition metal oxide may be a compound including a transition metal and oxygen. The type of the transition metal can be one or two or more. The transition metal oxide may be a compound composed of a transition metal and oxygen, or may be a compound including an element other than the transition metal and oxygen. Examples of the transition metal oxide include polyanion compounds such as phosphoric acid salts, sulfuric acid salts, and silicic acid salts. Examples of the phosphoric acid salts can include lithium phosphates having an olivine structure. Examples of the sulfuric acid salts can include iron sulfate.

Examples of the transition metal oxide include manganese dioxide (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese cobalt composite oxides (e.g., LiₓMn_{y}Co_{1-y}O₂; 0<x≤1, 0<y<1), lithium manganese nickel composite oxides having a spinel structure (e.g., LiₓMn_{2-y}Ni_{y}O₄; 0<x≤1, 0<y<2), lithium phosphates having an olivine structure (e.g., LiₓFePO₄; 0<x≤1, LiₓFe_{1-y}Mn_{y}PO₄; 0<x≤1, 0<y≤1, and LiₓCoPO₄; 0<x≤1), iron sulfate (Fe₂(SO₄)₃), vanadium oxides (e.g., V₂O₅), and lithium nickel cobalt manganese composite oxide (LiₓNi_{1-y-z}Co_{y}Mn_{z}O₂; 0<x≤1, 0<y<1, 0<z<1, y+z<1).

Among the above, examples of compounds more preferable as the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese nickel composite oxides having a spinel structure (e.g., LiₓMn_{2-y}Ni_{y}O₄; 0<x≤1, 0<y<2), lithium manganese cobalt composite oxide (e.g., LiₓMn_{y}Co_{1-y}O₂; 0<x≤1, 0<y<1), lithium iron phosphates (e.g., LiₓFePO₄; 0<x≤1), and lithium nickel cobalt manganese composite oxides (LiₓNi_{1-y-z}Co_{y}Mn_{z}O₂; 0<x≤1, 0<y<1, 0<z<1, y+z<1). The positive electrode potential can be made high by using these compounds as the positive electrode active material.

The binder is blended to fill gaps among the dispersed positive electrode active material and also to bind the positive electrode active material with the positive electrode current collector. Examples of the binder include polytetrafluoro ethylene (PTFE), polyvinylidene fluoride (PVdF), fluororubber, polyacrylic acid compounds, imide compounds, carboxymethyl cellulose (CMC), and salts of CMC. One of these may be used as the binder, or alternatively, two or more may be used in combination as the binder.

The electro-conductive agent is blended to improve current collection performance and to suppress contact resistance between the positive electrode active material and the positive electrode current collector. Examples of the electro-conductive agent include carbonaceous substances such as vapor grown carbon fiber (VGCF), carbon black such as acetylene black, and graphite. One of these may be used as the electro-conductive agent, or two or more may be used in combination as the electro-conductive agent. The electro-conductive agent may not be used.

In the positive electrode active material-containing layer, the positive electrode active material is preferably blended in a proportion of 80 mass % or more and 98 mass % or less. The titanium-containing solid electrolyte is preferably blended in a proportion of 0.05 mass % or more and 30 mass % or less. The binder is preferably blended in a proportion of 2 mass % or more and 20 mass % or less.

A total blending proportion of the positive electrode active material, titanium-containing solid electrolyte and binder can be 100 mass %. At this time, the blending proportion of each material may be an arbitrary value regardless of the above-described proportions. For example, in a case where the positive electrode active material is blended in the above proportion, the total blending proportion of the positive electrode active material, titanium-containing solid electrolyte and binder can be adjusted to 100 mass % by setting the blending proportions of the titanium-containing solid electrolyte and binder to arbitrary values. The blending proportion of the binder may be 0 mass %.

It is particularly preferable that the blending proportions of the positive electrode active material, titanium-containing solid electrolyte and binder all fall within the above numerical ranges, and that the total blending proportion thereof is 100 mass %.

Due to the amount of the binder of 2 mass % or more, sufficient electrode strength can be achieved. The binder may function as an electrical insulator. Thus, in a case where the amount of the binder is 20 mass % or less, the amount of electrical insulator in the electrode is reduced, and thus internal resistance can be decreased.

In a case where the electro-conductive agent is added, the positive electrode active material is preferably blended in a proportion of 77 mass % or more and 95 mass % or less. The titanium-containing solid electrolyte is preferably blended in a proportion of 0.05 mass % or more and 30 mass % or less. The binder is preferably blended in a proportion of 2 mass % or more and 20 mass % or less. The electro-conductive agent is preferably blended in a proportion of 3 mass % or more and 15 mass % or less.

A total blending proportion of the positive electrode active material, titanium-containing solid electrolyte, electro-conductive agent and binder can be 100 mass %. At this time, the blending proportion of each material may be an arbitrary value regardless of the above-described proportions. For example, in a case where the positive electrode active material is blended in the above proportion, the total blending proportion of the positive electrode active material, titanium-containing solid electrolyte, electro-conductive agent and binder can be adjusted to 100 mass % by setting the blending proportions of the titanium-containing solid electrolyte, electro-conductive agent and binder to arbitrary values. The blending proportion of the binder may be 0 mass %.

It is particularly preferable that the blending proportions of the positive electrode active material, titanium-containing solid electrolyte, electro-conductive agent and binder all fall within the above numerical ranges, and that the total blending proportion thereof is 100 mass %.

Due to the amount of the electro-conductive agent of 3 mass % or more, the above-described effects can be exhibited. Due to the amount of the electro-conductive agent of 15 mass % or less, the proportion of the electro-conductive agent to be contacted with the electrolyte can be reduced in a case where the electrode is used in combination with the electrolyte. In a case where this proportion is low, decomposition of the electrolyte can be reduced during storage at high temperatures.

The positive electrode current collector is preferably an aluminum foil, or an aluminum alloy foil including one or more selected from the group consisting of Mg, Ti, Zn, Ni, Cr, Mn, Fe, Cu, and Si. A thickness of the aluminum foil or aluminum alloy foil is preferably 5 μm or more and 20 μm or less, and more preferably 15 μm or less. A purity of the aluminum foil is preferably 99 mass % or more. Contents of transition metals such as iron, copper, nickel, and chromium included in the aluminum foil or aluminum alloy foil are preferably 1 mass % or less.

The positive electrode current collector may include a portion where the positive electrode active material-containing layer is not formed, on a surface thereof. This portion can serve as a positive electrode current-collecting tab.

The positive electrode can be fabricated, for example, by the following method. First, an active material, a titanium-containing solid electrolyte, an electro-conductive agent, and a binder are suspended in a solvent to prepare a slurry. The slurry is applied onto one side or both sides of a current collector. Then, the applied slurry is dried to obtain a stack of an active material-containing layer and the current collector. Then, the stack is subjected to pressing. The positive electrode is fabricated in this manner. In the fabrication of the positive electrode, for example, N-methylpyrrolidone (M4P) can be used as the solvent for the slurry.

Alternatively, the positive electrode may be fabricated by the following method. First, an active material, a titanium-containing solid electrolyte, an electro-conductive agent and a binder are mixed to obtain a mixture. Next, the mixture is formed into pellets. The positive electrode can then be obtained by disposing these pellets on the current collector.

The electrode according to the first embodiment includes an active material and a titanium-containing solid electrolyte. The active material includes a transition metal oxide.

In an X-ray absorption fine structure spectrum of Ti—K absorption edge for an electrode in a discharged state, a first X-ray absorption amount I at a first incident X-ray energy in a range of 4930 eV or more and 5000 eV or less satisfies 0.2≤I≤0.6, where an X-ray absorption amount at an incident X-ray energy of 5500 eV is 1.

In an X-ray absorption fine structure spectrum of Ti—K absorption edge for anatase titanium dioxide, a second X-ray absorption amount at a second incident X-ray energy in a range of 4930 eV or more and 5000 eV or less is equal to the first X-ray absorption amount I, where an X-ray absorption amount at an incident X-ray energy of 5500 eV is 1. The first incident X-ray energy is higher than the second incident X-ray energy. Therefore, the electrode can have improved cycle performance.

### Second Embodiment

According to a second embodiment, there is provided a secondary battery including a negative electrode, a positive electrode, and an electrolyte. At least one of the positive electrode and the negative electrode is the electrode according to the first embodiment. That is, the secondary battery includes the electrode according to the first embodiment.

The secondary battery may further include a separator provided between the positive electrode and the negative electrode. The negative electrode, the positive electrode, and the separator may configure an electrode group. The electrolyte may be held in the electrode group.

The secondary battery may further include a container member that houses the electrode group and the electrolyte.

The secondary battery may further include a negative electrode terminal electrically connected to the negative electrode and a positive electrode terminal electrically connected to the positive electrode.

The secondary battery may be, for example, a lithium secondary battery. The secondary battery also includes nonaqueous electrolyte secondary batteries including nonaqueous electrolyte(s).

Hereinafter, the negative electrode, positive electrode, electrolyte, separator, container member, negative electrode terminal, and positive electrode terminal will be described in detail.

### 1) Negative Electrode

The negative electrode may include a negative electrode current collector and a negative electrode active material-containing layer. The negative electrode current collector and the negative electrode active material-containing layer may respectively be the current collector and the active material-containing layer that can be included in the electrode according to the first embodiment. In a case where the electrode according to the first embodiment is included as the positive electrode, the negative electrode may not be the electrode according to the first embodiment. For example, the negative electrode may not include the titanium-containing solid electrolyte described in the first embodiment.

Of the details of the negative electrode, portions that overlap with the details described in the first embodiment are omitted.

A density of the negative electrode active material-containing layer (excluding the current collector) is preferably from 1.8 g/cm³ or more and 2.8 g/cm³ or less. A negative electrode including the negative electrode active material-containing layer having a density within this range is excellent in energy density and electrolyte retention. The density of the negative electrode active material-containing layer is more preferably 2.1 g/cm³ or more and 2.6 g/cm³ or less.

The negative electrode may be fabricated, for example, by the same method as that for the electrode according to the first embodiment.

### 2) Positive Electrode

The positive electrode may include a positive electrode current collector and a positive electrode active material-containing layer. The positive electrode current collector and the positive electrode active material-containing layer may respectively be the current collector and the active material-containing layer that can be included in the electrode according to the first embodiment. In a case where the electrode according to the first embodiment is included as the negative electrode, the positive electrode may not be the electrode according to the first embodiment. For example, the positive electrode may not include the titanium-containing solid electrolyte described in the first embodiment. Of the details of the positive electrode, portions that overlap with the details described in the first embodiment are omitted.

In a case where an ambient temperature molten salt is used as the electrolyte of the battery, it is preferable to use a positive electrode active material including lithium iron phosphate, LiₓVPO₄F (0≤x≤1), lithium manganese composite oxide, lithium nickel composite oxide, lithium nickel cobalt composite oxide, or a mixture thereof. Since these compounds have low reactivity with ambient temperature molten salts, cycle life can be improved. Details of the ambient temperature molten salt will be described later.

An average primary particle size of the positive electrode active material is preferably 100 nm or more and 1 μm or less. A positive electrode active material having an average primary particle size of 100 nm or more is easy to handle during industrial production. In a positive electrode active material having an average primary particle size of 1 μm or less, in-solid diffusion of lithium ions can proceed smoothly.

A specific surface area of the positive electrode active material is preferably 0.1 m²/g or more and 10 m²/g or less. A positive electrode active material having a specific surface area of 0.1 m²/g or more can sufficiently secure sites for inserting and extracting Li ions. A positive electrode active material having a specific surface area of 10 m²/g or less is easy to handle during industrial production, and can secure a good charge-discharge cycle performance.

The positive electrode may be fabricated, for example, by the same method as that for the electrode according to the first embodiment.

### 3) Electrolyte

As the electrolyte, for example, a liquid nonaqueous electrolyte or gel nonaqueous electrolyte can be used. The liquid nonaqueous electrolyte is prepared by dissolving an electrolyte salt as a solute in an organic solvent. A concentration of the electrolyte salt is preferably 0.5 mol/L or more and 2.5 mol/L or less.

Examples of the electrolyte salt include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂), and mixtures thereof. The electrolyte salt is preferably hard to oxidize even at a high potential, and is most preferably LiPF₆.

Examples of the organic solvent include cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2-MeTHF), and dioxolane (DOX); linear ethers such as dimethoxy ethane (DME) and diethoxy ethane (DEE); γ-butyrolactone (GBL), acetonitrile (AN), and sulfolane (SL). These organic solvents may be used singly or as a mixed solvent.

The gel nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

Alternatively, other than the liquid nonaqueous electrolyte and gel nonaqueous electrolyte, an ambient temperature molten salt (ionic melt) containing lithium ions, a polymeric solid electrolyte, an inorganic solid electrolyte, or the like may be used as the nonaqueous electrolyte.

The ambient temperature molten salt (ionic melt) refers to a compound among organic salts made of combinations of organic cations and anions, which is able to exist in a liquid state at an ambient temperature (15° C. or higher and 25° C. or lower). The ambient temperature molten salt includes an ambient temperature molten salt which exists alone as a liquid, an ambient temperature molten salt which becomes a liquid upon mixing with an electrolyte salt, an ambient temperature molten salt which becomes a liquid upon dissolution in an organic solvent, and mixtures thereof. In general, a melting point of the ambient temperature molten salt used in a secondary battery is 25° C. or lower. The organic cations generally have a quaternary ammonium skeleton.

The polymeric solid electrolyte is prepared by dissolving an electrolyte salt in a polymeric material, and solidifying it.

The inorganic solid electrolyte is a solid substance having Li ion conductivity. Having Li ion conductivity, as referred to herein, indicates exhibiting a lithium ion conductivity of 1×10⁻⁶ S/cm or more at 25° C. Examples of the inorganic solid electrolyte include oxide solid electrolytes and sulfide solid electrolytes. Specific examples of the inorganic solid electrolyte will be described below.

Preferably used as the oxide solid electrolyte is a lithium phosphate solid electrolyte having a sodium (Na) super ionic conductor (NASICON) structure and represented by a general formula Li₁₊ₓMα₂(PO₄)₃. Mα in the above general formula is, for example, one or more selected from the group consisting of titanium (Ti), germanium (Ge), strontium (Sr), zirconium (Zr), tin (Sn), aluminum (Al), and calcium (Ca). The subscript x is in a range of 0≤x≤2.

Specific examples of the lithium phosphate solid electrolyte having the NASICON structure include a LATP compound represented by Li₁₊ₓAlₓTi₂₋ₓ(PO₄)₃ where 0.1≤x≤0.5; a compound represented by Li₁₊ₓAl_{y}Mβ_{2-y}(PO₄)₃ where Mβ is one or more selected from the group consisting of Ti, Ge, Sr, Zr, Sn, and Ca, 0≤x≤1, and 0≤y≤1; a compound represented by Li₁₊ₓAlₓGe₂₋ₓ (PO₄)₃ where 0≤x≤2; a compound represented by Li₁₊ₓAlₓZr₂₋ₓ (PO₄)₃ where 0≤x≤2; a compound represented by Li_{1+x+y}AlₓMγ₂₋ₓSi_{y}P_{3-y}O₁₂ where Mγ is one or more selected from the group consisting of Ti and Ge, 0<x≤2, and 0≤y<3; and a compound represented by Li₁₊₂ₓZr₁₋ₓCaₓ(PO₄)₃ where 0≤x<1.

In addition to the above lithium phosphate solid electrolyte, examples of the oxide solid electrolyte include amorphous LIPON compounds represented by LiₓPO_{y}N_{z} where 2.6≤x≤3.5, 1.9≤y≤3.8, and 0.1≤z≤1.3 (e.g., Li_{2.9}PO_{3.3}N_{0.46}); a compound having a garnet structure represented by La₅₊ₓAₓLa₃₋ₓMδ₂O₁₂ where A is one or more selected from the group consisting of Ca, Sr, and Ba, Mδ is one or more selected from the group consisting of Nb and Ta, and 0≤x≤0.5; a compound represented by Li₃Mδ₂₋ₓL₂O₁₂ where Mδ is one or more selected from the group consisting of Nb and Ta, L may include Zr, and 0≤x≤0.5; a compound represented by Li₇₋₃ₓAlₓLa₃Zr₃O₁₂ where 0≤x≤0.5; an LLZ compound represented by Li₅₊ₓLa₃Mδ₂₋ₓZrₓO₁₂ where Mδ is one or more selected from the group consisting of Nb and Ta, and 0≤x≤2 (e.g., Li₇La₃Zr₂O₁₂); and a compound having a perovskite structure and represented by La_{2/3-x}LiₓTiO₃ where 0.3≤x≤0.7.

One or more among the above compounds may be used as the solid electrolyte. Two or more of the above solid electrolytes may be used.

### 4) Separator

The separator may be made of, for example, a porous film or synthetic resin nonwoven fabric including polyethylene (PE), polypropylene (PP), cellulose, or polyvinylidene fluoride (PVdF). In view of safety, a porous film made of polyethylene or polypropylene is preferred. This is because, at a certain temperature, such a porous film melts and can shut off current.

### 5) Container Member

As the container member, for example, a container made of a laminate film or a container made of a metal may be used.

A thickness of the laminate film is, for example, 0.5 mm or less, and preferably 0.2 mm or less.

As the laminate film, used is a multilayer film including a plurality of resin layers and a metal layer sandwiched between the respective resin layers. The resin layer may include, for example, a polymeric material such as polypropylene (PP), polyethylene (PE), nylon, or polyethylene terephthalate (PET). The metal layer is preferably made of an aluminum foil or an aluminum alloy foil, in order to reduce weight. The laminate film may be formed into the shape of the container member, by heat-sealing.

A wall thickness of the metal container is, for example, 1 mm or less, more preferably 0.5 mm or less, and further preferably 0.2 mm or less.

The metal container is made, for example, of aluminum or an aluminum alloy. The aluminum alloy preferably includes elements such as magnesium, zinc, and silicon. In a case where the aluminum alloy includes a transition metal such as iron, copper, nickel, or chromium, a content thereof is preferably 100 ppm by mass or less.

The shape of the container member is not particularly limited. The shape of the container member may be, for example, flat (thin), prismatic, cylindrical, coin-shaped, or button-shaped. The container member may be appropriately selected depending on the battery dimensions and the use of the battery.

### 6) Negative Electrode Terminal

The negative electrode terminal may be formed of a material that is electrically stable in a potential range of 1 V or more and 3 V or less (vs. Li/Li⁺) relative to an oxidation-reduction potential of lithium, and having electrical conductivity. Specific examples of the material for the negative electrode terminal include copper, nickel, stainless steel, and aluminum, and aluminum alloys including at least one selected from the group consisting of Mg, Ti, Zn, Mn, Fe, Cu, and Si. Aluminum or an aluminum alloy is preferably used as the material for the negative electrode terminal. The negative electrode terminal is preferably made of the same material as the negative electrode current collector, in order to reduce contact resistance between the negative electrode terminal and the negative electrode current collector.

### 7) Positive Electrode Terminal

The positive electrode terminal can be formed of a material that is electrically stable in a potential range of 3 V or more and 4.5 V or less (vs. Li/Li⁺) relative to the oxidation-reduction potential of lithium, and having electrical conductivity. Examples of the material for the positive electrode terminal include aluminum and aluminum alloys including at least one selected from the group consisting of Mg, Ti, Zn, Mn, Fe, Cu, and Si. The positive electrode terminal is preferably formed of the same material as the positive electrode current collector, in order to reduce contact resistance between the positive electrode terminal and the positive electrode current collector.

Next, the secondary battery according to the embodiment will be more specifically described with reference to the drawings.

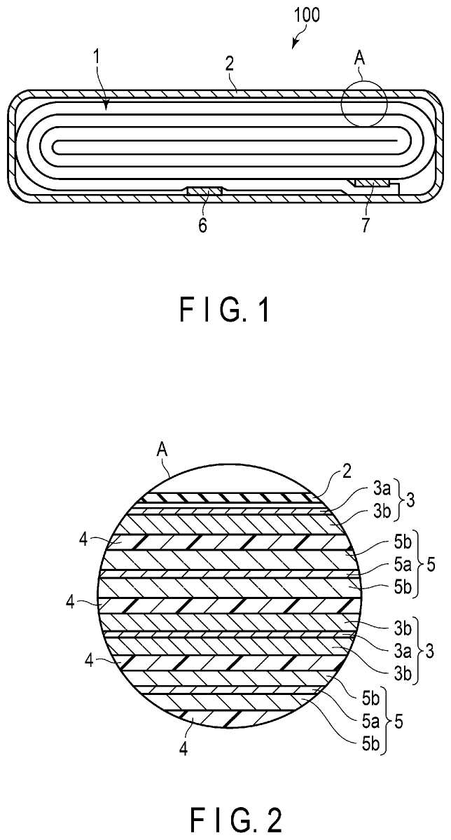

FIG. 1 is a cross-sectional view schematically illustrating an example of a secondary battery. FIG. 2 is an enlarged cross-sectional view of a section A of the secondary battery illustrated in FIG. 1.

A secondary battery 100 as illustrated in FIGS. 1 and 2 includes a bag-shaped container member 2 as illustrated in FIG. 1, an electrode group 1 as illustrated in FIGS. 1 and 2, and an electrolyte which is not illustrated. The electrode group 1 and the electrolyte are housed in the bag-shaped container member 2. The electrolyte (not illustrated) is held in the electrode group 1.

The bag-shaped container member 2 is made of a laminate film including two resin layers and a metal layer sandwiched between the resin layers.

As illustrated in FIG. 1, the electrode group 1 is a wound electrode group in a flat form. The wound electrode group 1 in a flat form includes a negative electrode 3, a separator 4, and a positive electrode 5, as illustrated in FIG. 2. The separator 4 is sandwiched between the negative electrode 3 and the positive electrode 5.

The negative electrode 3 includes a negative electrode current collector 3a and a negative electrode active material-containing layer 3b. At a portion of the negative electrode 3 positioned outermost among the wound electrode group 1, the negative electrode active material-containing layer 3b is formed only on an inner surface of the negative electrode current collector 3a, as illustrated in FIG. 2. For the other portions of the negative electrode 3, the negative electrode active material-containing layers 3b are formed on both sides of the negative electrode current collector 3a.

The positive electrode 5 includes a positive electrode current collector 5a and positive electrode active material-containing layers 5b formed on both sides of the positive electrode current collector 5a.

As illustrated in FIG. 1, a negative electrode terminal 6 and a positive electrode terminal 7 are positioned in vicinity of an outer peripheral end of the wound electrode group 1. The negative electrode terminal 6 is connected to a portion of the negative electrode current collector 3a positioned outermost. The positive electrode terminal 7 is connected to a portion of the positive electrode current collector 5a positioned outermost. The negative electrode terminal 6 and the positive electrode terminal 7 extend outside from an opening of the bag-shaped container member 2. A thermoplastic resin layer is provided on an inner surface of the bag-shaped container member 2, and the opening is closed by heat-sealing the thermoplastic resin layer.

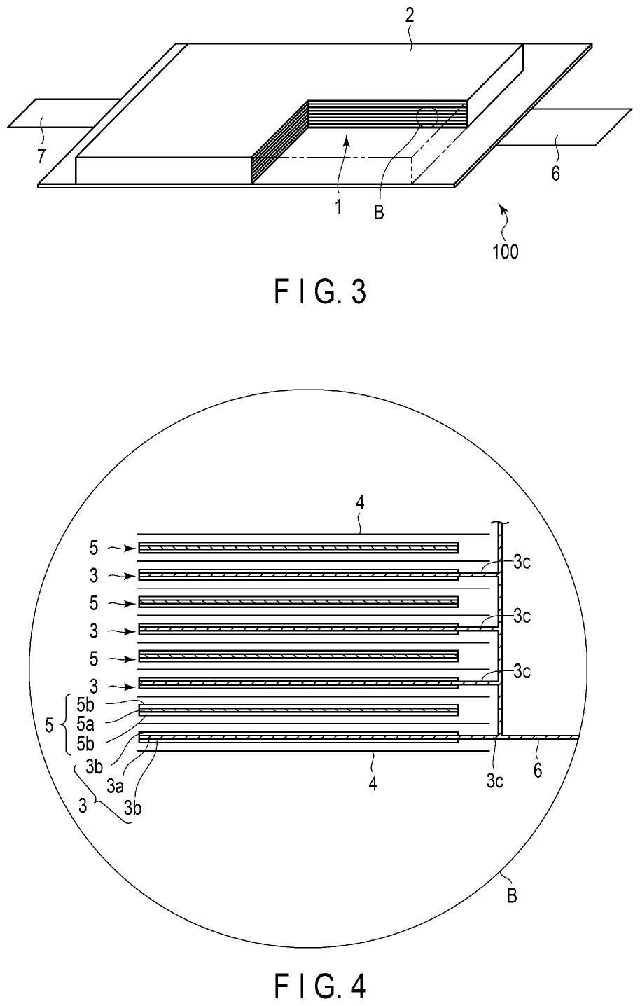

The secondary battery according to the embodiment is not limited to the secondary battery having the structure illustrated in FIGS. 1 and 2, and may be, for example, a battery having a structure as illustrated in FIGS. 3 and 4.

FIG. 3 is a partially cut-out perspective view schematically illustrating another example of the secondary battery. FIG. 4 is an enlarged cross-sectional view of a section B of the secondary battery illustrated in FIG. 3.

A secondary battery 100 as illustrated in FIGS. 3 and 4 includes an electrode group 1 as illustrated in FIGS. 3 and 4, a container member 2 as illustrated in FIG. 3, and an electrolyte which is not illustrated. The electrode group 1 and the electrolyte are housed in the container member 2. The electrolyte is held in the electrode group 1.

The container member 2 is made of a laminate film including two resin layers and a metal layer sandwiched between the resin layers.

As illustrated in FIG. 4, the electrode group 1 is a stacked electrode group. The stacked electrode group 1 has a structure in which negative electrodes 3 and positive electrodes 5 are alternately stacked with separators 4 sandwiched therebetween.

The electrode group 1 includes a plurality of the negative electrodes 3. Each of the negative electrodes 3 includes a negative electrode current collector 3a and negative electrode active material-containing layers 3b supported on both sides of the negative electrode current collector 3a. The electrode group 1 further includes a plurality of the positive electrodes 5. Each of the positive electrodes 5 includes a positive electrode current collector 5a and positive electrode active material-containing layers 5b supported on both sides of the positive electrode current collector 5a.

The negative electrode current collector 3a of each of the negative electrodes 3 includes, at one end, a portion where the negative electrode active material-containing layer 3b is not supported on either surface. This portion serves as a negative electrode current-collecting tab 3c. As shown in FIG. 4, the negative electrode current-collecting tabs 3c do not overlap the positive electrodes 5. A plurality of the negative electrode current-collecting tabs 3c are electrically connected to a strip-shaped negative electrode terminal 6. A tip of the strip-shaped negative electrode terminal 6 is drawn outside from the container member 2.

Although not illustrated, the positive electrode current collector 5a of each of the positive electrodes 5 includes, at one end, a portion where the positive electrode active material-containing layer 5b is not supported on either surface. This portion serves as a positive electrode current-collecting tab. Like the negative electrode current-collecting tabs 3c, the positive electrode current-collecting tabs do not overlap the negative electrodes 3. Further, the positive electrode current-collecting tabs are located on an opposite side of the electrode group 1 relative to the negative electrode current-collecting tabs 3c. The positive electrode current-collecting tabs are electrically connected to a strip-shaped positive electrode terminal 7. A tip of the strip-shaped positive electrode terminal 7 is located on an opposite side relative to the negative electrode terminal 6 and drawn outside from the container member 2.

The secondary battery according to the second embodiment includes the electrode according to the first embodiment. Therefore, the secondary battery can have improved cycle performance.

### Third Embodiment

According to a third embodiment, a battery module is provided. The battery module includes a plurality of the secondary batteries according to the second embodiment.

In the battery module, each of single-batteries may be disposed to be electrically connected in series or in parallel, or may be disposed in a combination of series connection and parallel connection.

Next, an example of the battery module according to the embodiment will be described, with reference to the drawings.

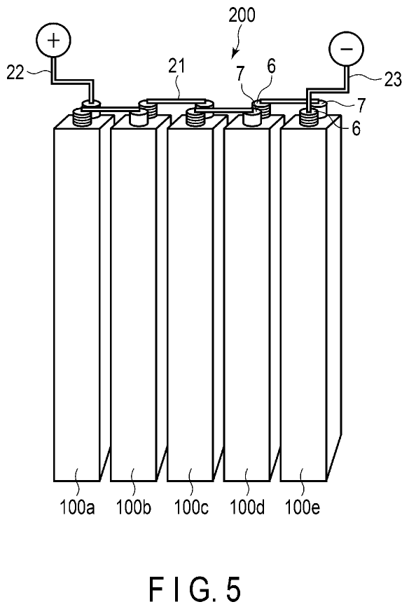

FIG. 5 is a perspective view schematically illustrating an example of a battery module. A battery module 200 illustrated in FIG. 5 includes five single-batteries 100a to 100e, four bus bars 21, a positive electrode-side lead 22, and a negative electrode-side lead 23. Each of the five single-batteries 100a to 100e is the secondary battery according to the second embodiment.

The bus bar 21 connects, for example, a negative electrode terminal 6 of the one single-battery 100a and a positive electrode terminal 7 of the single-battery 100b positioned adjacent thereto. In such a manner, the five single-batteries 100 are thus connected in series by the four bus bars 21. That is, the battery module 200 illustrated in FIG. 5 is a battery module in which five single-batteries are connected in series. Although no example is illustrated, in a battery module including a plurality of single-batteries that are electrically connected in parallel, for example, the single-batteries may be electrically connected by having a plurality of negative electrode terminals connected to each other by bus bars and also having a plurality of positive electrode terminals connected to each other by bus bars.

The positive electrode terminal 7 of at least one battery among the five single-batteries 100a to 100e is electrically connected to the positive electrode-side lead 22 for external connection. In addition, the negative electrode terminal 6 of at least one battery among the five single-batteries 100a to 100e is electrically connected to the negative electrode-side lead 23 for external connection.

The battery module according to the third embodiment includes the secondary battery according to the second embodiment. This contributes to achievement of excellent cycle performance.

### Fourth Embodiment

According to a fourth embodiment, a battery pack is provided. The battery pack includes the battery module according to the third embodiment. The battery pack may include a single secondary battery according to the second embodiment, in place of the battery module according to the third embodiment.

The battery pack may further include a protective circuit. The protective circuit has a function to control charge and discharge of the secondary battery. Alternatively, a circuit included in an apparatus where the battery pack is used as a power source (for example, an electronic device or an automobile) may be used as the protective circuit for the battery pack.

Moreover, the battery pack may further include an external power distribution terminal. The external power distribution terminal is configured to externally output current from the secondary battery, and/or to input external current into the secondary battery. In other words, in a case where the battery pack is used as a power source, the current is supplied outside via the external power distribution terminal. When the battery pack is charged, charge current (including regenerative energy of motive force of a vehicle such as an automobile) is supplied to the battery pack via the external power distribution terminal.

Next, an example of the battery pack according to the embodiment will be described, with reference to the drawings.

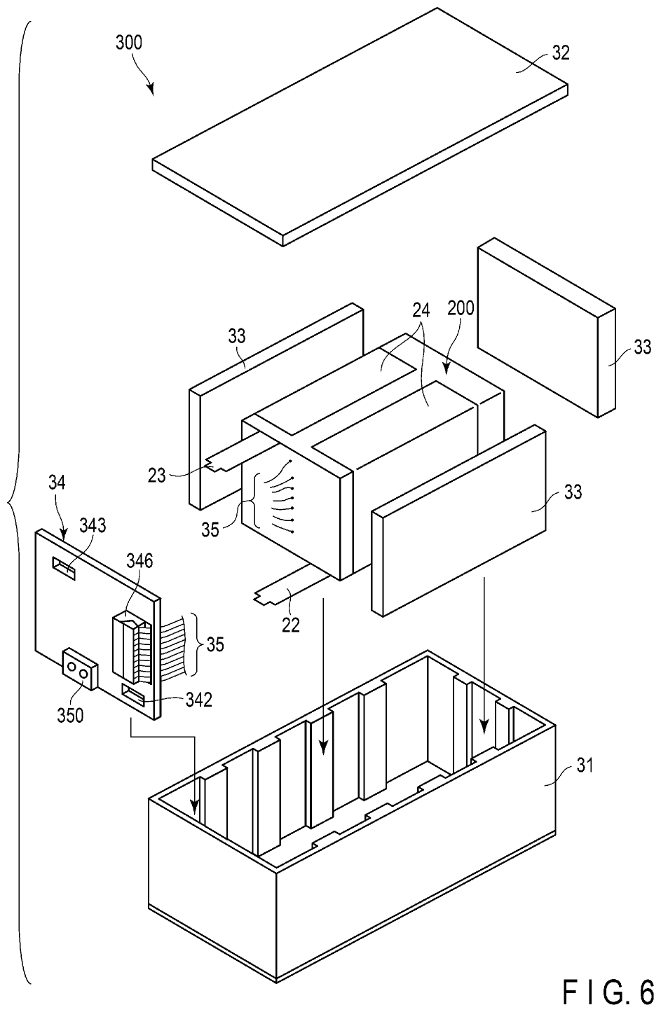

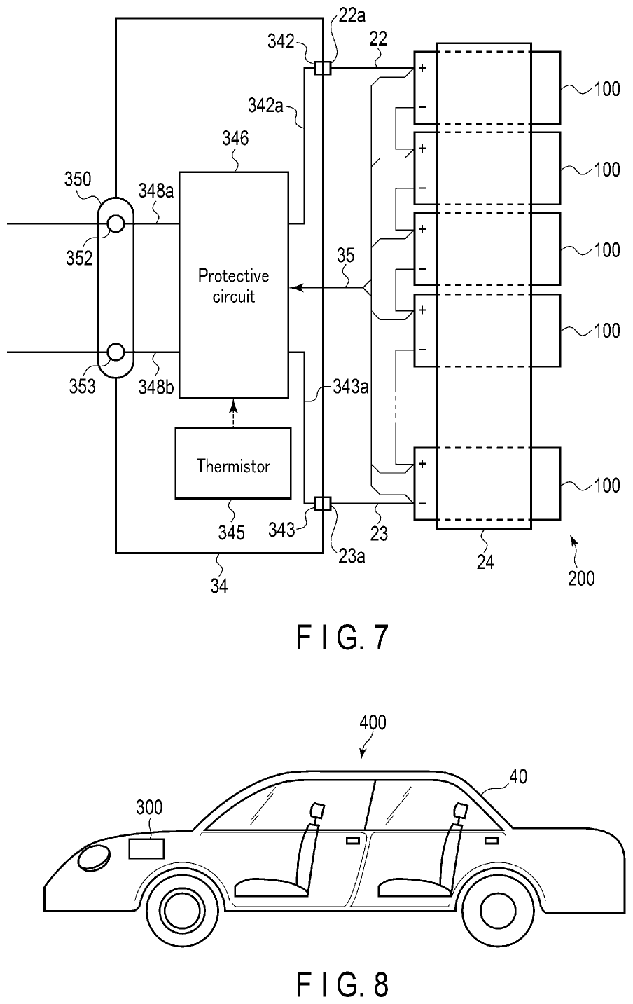

FIG. 6 is an exploded perspective view schematically illustrating an example of a battery pack. FIG. 7 is a block diagram illustrating an example of an electric circuit of the battery pack illustrated in FIG. 6.

A battery pack 300 as illustrated in FIGS. 6 and 7 includes a housing container 31, a lid 32, protective sheets 33, a battery module 200, a printed wiring board 34, wirings 35, and an insulating plate (not illustrated).

The housing container 31 illustrated in FIG. 6 is a prismatic bottomed container having a rectangular bottom surface. The housing container 31 is configured to be capable of housing the protective sheets 33, the battery module 200, the printed wiring board 34, and the wirings 35. The lid 32 has a rectangular shape. The lid 32 covers the housing container 31 to house the battery module 200 and the like. Although not illustrated, the housing container 31 and the lid 32 are provided with openings, connection terminals, or the like for connection to an external device or the like.

The battery module 200 includes a plurality of single-batteries 100, a positive electrode-side lead 22, a negative electrode-side lead 23, and adhesive tapes 24.

At least one of the single-batteries 100 is the secondary battery according to the second embodiment. The single-batteries 100 are electrically connected in series, as illustrated in FIG. 7. The single-batteries 100 may be electrically connected in parallel, or connected in a combination of in series and in parallel. If the single-batteries 100 are connected in parallel, battery capacity increases as compared to a case in which they are connected in series.

The adhesive tapes 24 fasten the single-batteries 100. Instead of the adhesive tape 24, a heat-shrinkable tape may be used to fix the single-batteries 100. In this case, the protective sheets 33 are disposed on both side surfaces of the battery module 200, and the heat shrinkable tape is wound around the battery module 200 and protective sheets 33. After that, the heat shrinkable tape is shrunk by heating to bundle the single-batteries 100.

One end of the positive electrode-side lead 22 is connected to the battery module 200. The one end of the positive electrode-side lead 22 is electrically connected to positive electrode(s) of one or more of the single-batteries 100. One end of the negative electrode-side lead 23 is connected to the battery module 200. The one end of the negative electrode-side lead 23 is electrically connected to negative electrode(s) of one or more of the single-batteries 100.

The printed wiring board 34 is provided along one face in the short side direction among inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces a side surface of the battery module 200. An insulating plate (not illustrated) is sandwiched between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each of the single-batteries 100 and transmits detection signals to the protective circuit 346.

The external power distribution terminal 350 is fixed to the other principal surface of the printed wiring board 34. The external power distribution terminal 350 is electrically connected to a device that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the single-batteries 100 via the wiring 35.

The protective sheets 33 are disposed on both inner side surfaces of the housing container 31 in the long side direction and on the inner side surface in the short side direction facing the printed wiring board 34 across the battery module 200. The protective sheets 33 are made of, for example, resin or rubber.

The protective circuit 346 controls charge and discharge of the single-batteries 100. The protective circuit 346 is also configured to cut-off electric connection between the protective circuit 346 and the external power distribution terminal 350 (positive-side terminal 352, negative-side terminal 353) to an external device, based on detection signals transmitted from the thermistor 345 or detection signals transmitted from each of the single-batteries 100 or the battery module 200.

An example of the detection signal transmitted from the thermistor 345 is a signal indicating that the temperature of the single-battery(s) 100 is detected to be a predetermined temperature or higher. Examples of the detection signal transmitted from each of the single-batteries 100 or the battery module 200 include signals indicating detection of over-charge, over-discharge, and overcurrent of the single-battery(s) 100. In a case where over-charge or the like for each of the single-batteries 100 is detected, the battery voltage may be detected, or a positive electrode potential or negative electrode potential may be detected. In the latter case, a lithium electrode to be used as a reference electrode is inserted into each of the single-batteries 100.

Note that, as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when the battery pack 300 is used as a power source, the current from the battery module 200 is supplied to an external device via the external power distribution terminal 350. When the battery pack 300 is charged, a charge current from an external device is supplied to the battery pack 300 via the external power distribution terminal 350. If the battery pack 300 is used as an onboard battery, regenerative energy of motive force of a vehicle can be used as the charge current from the external device.

Note that the battery pack 300 may include a plurality of the battery modules 200. In this case, the battery modules 200 may be connected in series, may be connected in parallel, or may be connected in a combination of in series and in parallel. The printed wiring board 34 and the wirings 35 may not be used. In this case, the positive electrode-side lead 22 and the negative electrode-side lead 23 may respectively be used as the positive-side terminal 352 and negative-side terminal 353 of the external power distribution terminal 350.

Such a battery pack is used, for example, in applications where excellent cycle performance is demanded when a large current is extracted. More specifically, the battery pack is used as, for example, a power source for electronic devices, a stationary battery, or an onboard battery for various types of vehicles. An example of the electronic device can be a digital camera. The battery pack is particularly suitably used as the onboard battery.

The battery pack according to the fourth embodiment includes the secondary battery according to the second embodiment or the battery module according to the third embodiment. Therefore, the battery pack can achieve excellent cycle performance.

### Fifth Embodiment

According to a fifth embodiment, a vehicle is provided. This vehicle is mounted with the battery pack according to the fourth embodiment.

In the vehicle, the battery pack is configured, for example, to recover regenerative energy from motive force of the vehicle. The vehicle may include a mechanism (regenerator) configured to convert kinetic energy of the vehicle into regenerative energy.

Examples of the vehicle include two-wheeled to four-wheeled hybrid electric automobiles, two-wheeled to four-wheeled electric automobiles, electrically assisted bicycles, and railway cars.

The mounting position of the battery pack within the vehicle is not particularly limited. For example, in a case where the battery pack is mounted in an automobile, the battery pack may be mounted in an engine compartment of the vehicle, in a rear part of the vehicle body, or under a seat.

The vehicle may be mounted with a plurality of the battery packs. In this case, batteries included in each of the battery packs may be electrically connected in series, electrically connected in parallel, or electrically connected in a combination of in series and in parallel. For example, when each of the battery packs includes a battery module, the battery modules may be electrically connected in series, may be electrically connected in parallel, or may be electrically connected in a combination of in series and in parallel. Alternatively, in a case where each of the battery packs includes a single battery, the batteries may be electrically connected in series, electrically connected in parallel, or electrically connected in a combination of in series and in parallel.

Next, an example of the vehicle according to the embodiment will be described, with reference to the drawings.

FIG. 8 is a partially see-through diagram schematically illustrating an example of a vehicle.

A vehicle 400 as illustrated in FIG. 8 includes a vehicle body 40 and a battery pack 300 according to the fourth embodiment. In the example illustrated in FIG. 8, the vehicle 400 is a four-wheeled automobile.

This vehicle 400 may have a plurality of battery packs 300 mounted therein. In this case, the batteries (e.g., single-batteries or battery modules) included in the battery packs 300 may be connected in series, connected in parallel, or connected in a combination of in series and in parallel.

In FIG. 8, illustrated is an example where the battery pack 300 is mounted in an engine compartment located at the front of the vehicle body 40. As described above, for example, the battery pack 300 may be alternatively mounted in a rear part of the vehicle body 40, or under a seat. The battery pack 300 may be used as a power source for the vehicle 400. The battery pack 300 can also recover regenerative energy of motive force of the vehicle 400.

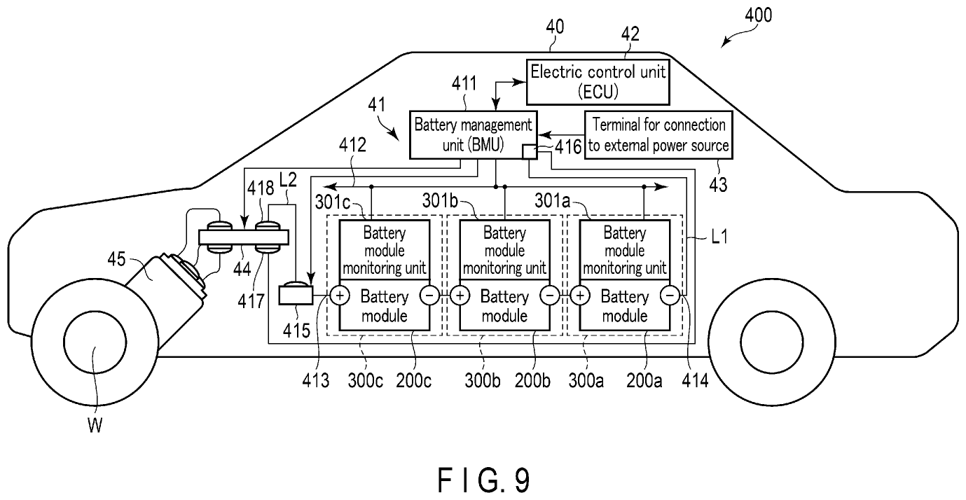

Next, with reference to FIG. 9, an aspect of operation of the vehicle according to the embodiment will be described.

FIG. 9 is a diagram schematically illustrating an example of a control system related to an electric system in the vehicle. A vehicle 400 as illustrated in FIG. 9 is an electric automobile.

The vehicle 400 illustrated in FIG. 9 includes a vehicle body 40, a vehicle power source 41, a vehicle electric control unit (ECU) 42, which is a master controller of the vehicle power source 41, an external terminal (a terminal for connection to an external power source) 43, an inverter 44, and a drive motor 45.

The vehicle 400 includes the vehicle power source 41, for example, in an engine compartment, in a rear part of the vehicle body of the automobile, or under a seat. In FIG. 9, the position of the vehicle power source 41 mounted in the vehicle 400 is schematically illustrated.

The vehicle power source 41 includes a plurality of (for example, three) battery packs 300a, 300b and 300c, a battery management unit (BMU) 411, and a communication bus 412.

The battery pack 300a includes a battery module 200a and a battery module monitoring unit 301a (e.g., a VTM: voltage temperature monitoring). The battery pack 300b includes a battery module 200b and a battery module monitoring unit 301b. The battery pack 300c includes a battery module 200c and a battery module monitoring unit 301c. The battery packs 300a to 300c are battery packs similar to the above-described battery pack 300, and the battery modules 200a to 200c are battery modules similar to the above-described battery module 200. The battery modules 200a to 200c are electrically connected in series. The battery packs 300a, 300b and 300c can each be independently removed, and may be exchanged by a different battery pack 300.

Each of the battery modules 200a to 200c includes a plurality of single-batteries connected in series. At least one of the single-batteries is the secondary battery according to the second embodiment. The battery modules 200a to 200c each perform charge and discharge via a positive electrode terminal 413 and a negative electrode terminal 414.

The battery management unit 411 performs communication with the battery module monitoring units 301a to 301c and collects information on a voltage, a temperature or the like of each of the single-batteries 100 included in the battery modules 200a to 200c included in the vehicle power source 41. In this manner, the battery management unit 411 collects information on security of the vehicle power source 41.

The battery management unit 411 and the battery module monitoring units 301a to 301c are connected via the communication bus 412. In the communication bus 412, a set of communication lines is shared at a plurality of nodes (i.e., the battery management unit 411 and one or more battery module monitoring units 301a to 301c). The communication bus 412 is, for example, a communication bus configured based on CAN (control area network) standard.

The battery module monitoring units 301a to 301c measure a voltage and a temperature of each of the single-batteries in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 illustrated in FIG. 9) for switching on and off electrical connection between the positive electrode terminal 413 and the negative electrode terminal 414. The switch unit 415 includes a precharge switch (not illustrated), which is turned on when the battery modules 200a to 200c are charged, and a main switch (not illustrated), which is turned on when output from the battery modules 200a to 200c is supplied to a load. The precharge switch and the main switch each include a relay circuit (not illustrated), which is switched on or off based on a signal provided to a coil disposed near the switch elements. The electromagnetic contactor such as the switch unit 415 is controlled based on control signals from the battery management unit 411, or the vehicle ECU 42 which controls the operation of the entire vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management unit 411, or the vehicle ECU 42 which controls the entire operation of the vehicle. Due to the inverter 44 being controlled, output voltage from the inverter 44 is adjusted.

The drive motor 45 is rotated by electric power supplied from the inverter 44. The drive force generated by rotation of the drive motor 45 is transferred to an axle and driving wheels W via a differential gear unit, for example.

The vehicle 400 also includes a regenerative brake mechanism (regenerator), though not illustrated. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connecting line L1 is connected to the negative electrode terminal 414 of the vehicle power source 41. The other terminal of the connecting line L1 is connected to a negative electrode input terminal 417 of the inverter 44. A current detector (current detecting circuit) 416 in the battery management unit 411 is provided on the connecting line L1 between the negative electrode terminal 414 and negative electrode input terminal 417.

One terminal of a connecting line L2 is connected to the positive electrode terminal 413 of the vehicle power source 41. The other terminal of the connecting line L2 is connected to a positive electrode input terminal 418 of the inverter 44. The switch unit 415 is provided on the connecting line L2 between the positive electrode terminal 413 and the positive electrode input terminal 418.

The external terminal 43 is connected to the battery management unit 411. The external terminal 43 can be connected, for example, to an external power source.

The vehicle ECU 42 performs cooperative control of the vehicle power source 41, the switch unit 415, the inverter 44, and the like, together with other management units and control units including the battery management unit 411 in response to inputs operated by a driver or the like. Through the cooperative control by the vehicle ECU 42 and the like, output of electric power from the vehicle power source 41, charge of the vehicle power source 41, and the like are controlled, thereby performing management of the whole vehicle 400. Data on the security of the vehicle power source 41, such as a remaining capacity of the vehicle power source 41, are transferred between the battery management unit 411 and the vehicle ECU 42 via communication lines.

The vehicle according to the fifth embodiment is mounted with the battery pack according to the fourth embodiment. Therefore, the vehicle has high reliability because of high cycle performance of the battery pack.

### EXAMPLES

Examples will be described below, but the embodiments are not limited to the examples which will be described below.

### Example 1

### <Surface Treatment of LATP>

As LATP particles, particles of Li_{1.3}Al_{0.3}Ti_{1.7}(PO₄)₃ were provided. The surface treatment of the LATP particles was performed as follows. In a polytetrafluoroethylene (PTFE) beaker, put was 2 mass % of an aqueous hydrofluoric acid solution, and the LATP particles were charged into the solution. Stirring was performed at 45° C. for 80 hours. After stirring, the LATP particles were extracted and washed with water. Thus, surface-treated LATP particles were obtained.

### <Fabrication of Negative Electrode>

As a negative electrode active material, a monoclinic niobium titanium oxide (Nb₂TiO₇) powder was provided. An average secondary particle size of the niobium titanium oxide powder was 7.5 μm. A specific surface area of the niobium titanium oxide powder was 4.0 m²/g. In addition, acetylene black was provided as an electro-conductive agent, and CMC and SBR were provided as binders. As a titanium-containing solid electrolyte, the surface-treated LATP particles described above were provided. Next, the negative electrode active material, electro-conductive agent, CMC, SBR, and titanium-containing solid electrolyte were added to water as a solvent in proportions of 88 mass %: 5 mass %: 2 mass %: 2 mass %: 3 mass %, and mixed to prepare a negative electrode slurry. The negative electrode slurry was applied to both sides of a current collector made of an aluminum foil having a thickness of 15 μm. Next, the coating film was dried in a thermostatic bath at 120° C. to form a negative electrode active material-containing layer. The negative electrode active material-containing layer was pressed to obtain a negative electrode.

### Examples 2 to 9

A negative electrode was fabricated in the same manner as in Example 1 except that the hydrofluoric acid concentration, stirring temperature, and stirring time in the surface treatment of LATP were changed as shown in Table 1.

### Comparative Example 1

A negative electrode was fabricated in the same manner as in Example 1 except that surface-untreated LATP particles were used as the titanium-containing solid electrolyte instead of the surface-treated LATP particles in the fabrication of the negative electrode. Since the LATP was not surface-treated in Comparative Example 1, “-” was indicated in the columns of hydrofluoric acid concentration, stirring temperature, and stirring time for Comparative Example 1 in Table 1.

### Example 10

The surface treatment of LATP was performed in the same manner as in Example 1.

### <Fabrication of Positive Electrode>

A lithium nickel cobalt manganese composite oxide (LiNi_{0.5}Co_{0.2}Mn_{0.3}O₂) powder was provided as a positive electrode active material. Acetylene black was provided as the electro-conductive agent. Polyvinylidene fluoride (PVdF) was provided as the binder. As a titanium-containing solid electrolyte, the surface-treated LATP particles described above were provided. Next, the positive electrode active material, electro-conductive agent, binder, and titanium-containing solid electrolyte were added to N-methylpyrrolidone (NMP) as a solvent in proportions of 87 mass %: 5 mass %: 5 mass %: 3 mass %, and mixed to prepare a positive electrode slurry. The positive electrode slurry was applied to both sides of a current collector made of an aluminum foil having a thickness of 15 μm. Next, the coating film was dried in a thermostatic bath at 120° C. to form a positive electrode active material-containing layer. The positive electrode active material-containing layer was pressed to obtain a positive electrode.

### Examples 11 to 18

A positive electrode was fabricated in the same manner as in Example 10 except that the hydrofluoric acid concentration, stirring temperature, and stirring time in the surface treatment of LATP were changed as shown in Table 2.

### Comparative Example 2

A positive electrode was fabricated in the same manner as in Example 10 except that the surface-treated LATP particles were changed to surface-untreated LATP particles in the preparation of the positive electrode slurry. Since the LATP was not surface-treated in Comparative Example 2, “-” was indicated in the columns of hydrofluoric acid concentration, stirring temperature, and stirring time for Comparative Example 2 in Table 2.

### <Fabrication of Electrochemical Measurement Cell>

An electrochemical measurement cell was fabricated using a measurement electrode, a metal lithium foil as a counter electrode, and a nonaqueous electrolyte. As the measurement electrode, the electrode fabricated in each of the Examples and the Comparative Examples was used. The nonaqueous electrolyte was prepared by dissolving lithium hexafluorophosphate (LiPF₆) at a concentration of 1 M in a mixed solvent of ethylene carbonate and diethyl carbonate (volume ratio 1:1).

### <Measurement of 0.2 C Discharge Capacity>

### Examples 1 to 9 and Comparative Example 1

The fabricated electrochemical measurement cell was charged and discharged at room temperature in a potential range of 1.0 V to 3.0 V based on a metal lithium electrode. Current values at the time of charge and discharge were 0.2 C (time discharge rate). A capacity at the time of discharge was measured and defined as a 0.2 C discharge capacity (initial discharge capacity).

### Examples 10 to 18 and Comparative Example 2

The capacity at the time of discharge was measured in the same manner as in Examples 1 to 9 and Comparative Example 1 except that the potential range of charge and discharge of the electrochemical measurement cell was changed to 3.0 V to 4.2 V based on the metal lithium electrode, and was defined as the 0.2 C discharge capacity (initial discharge capacity).

### <Measurement of 10 C/0.2 C Discharge Capacity Ratio>

The electrochemical measurement cell was charged and discharged in the same manner as in the measurement of the 0.2 C discharge capacity performed on each of the Examples and the Comparative Examples, except that the current value at the time of discharge was changed to 10 C. The capacity at the time of discharge was measured and defined as a 10 C discharge capacity. A ratio of the 10 C discharge capacity to the initial discharge capacity was determined.

### <Charge-Discharge Cycle Test>

### Examples 1 to 9 and Comparative Example 1

The electrochemical measurement cell was charged and discharged at room temperature in the potential range of 1.0 V to 3.0 V based on the metal lithium electrode. Current values at the time of charge and discharge were 1 C.

The above charge and discharge were defined as one charge-discharge cycle. This charge-discharge cycle was repeated 100 times at room temperature.

The 0.2 C discharge capacity was measured in the same manner as described above for the electrochemical measurement cell after repetition of 100 cycles of charge and discharge. The discharge capacity at this time was defined as a discharge capacity after 100 cycles. The discharge capacity after 100 cycles was divided by the initial discharge capacity, and the obtained value was multiplied by 100 to calculate a capacity maintenance rate (%) on the condition that the initial discharge capacity was 100%.

### Examples 10 to 18 and Comparative Example 2

The capacity maintenance rate (%) was calculated through a charge-discharge cycle test performed in the same manner as in Examples 1 to 9 and Comparative Example 1 except that the potential range of charge and discharge of the electrochemical measurement cell was changed to 3.0 V to 4.2 V based on the metal lithium electrode.

### <Provision of Measurement Sample>

As a measurement sample, a commercially available anatase titanium dioxide powder having a purity of 99.5% was provided. In addition, the electrodes of the Examples and the Comparative Examples were brought into a discharged state as follows to prepare measurement samples.

The electrochemical measurement cell was discharged at 0.05 C, and adjustment was made so that the potential of the measurement electrode was 3.0 V based on metal lithium. The electrodes were brought into the discharged state in this manner.

In an argon box, the electrodes in the discharged state were extracted from the electrochemical measurement cell, and washed with methyl ethyl carbonate (MEC). The washed electrodes were vacuum-dried to obtain measurement samples.

### <XAFS Analysis>

The electrodes of the Examples and the Comparative Examples and the measurement sample of the anatase titanium dioxide were subjected to XAFS analysis in the same manner as described above. The XAFS analysis was performed using BL16B2 of SPring-8.

The normalized spectra for the electrodes of the Examples and the Comparative Examples and the normalized spectra for the anatase titanium dioxide were compared as follows to calculate a shift amount.

From the normalized spectrum for the electrode of each of the Examples and the Comparative Examples, a point was taken where a first X-ray absorption amount at a first incident X-ray energy in a range where the incident X-ray energy was 4930 eV or more and 5000 eV or less was 0.2. From the normalized spectrum for the anatase titanium dioxide, a point was taken where a second X-ray absorption amount at a second incident X-ray energy in a range where the incident X-ray energy was 4930 eV or more and 5000 eV or less was 0.2.

A difference between the first incident X-ray energy (eV) and the second incident X-ray energy (eV) for each point was calculated and defined as “shift amount (eV) from TiO₂, I=0.2”.

In the same manner as described above, a point where the first X-ray absorption amount was 0.5 and a point where the second X-ray absorption amount was 0.5 were taken from each spectrum. A difference between the first incident X-ray energy (eV) and the second incident X-ray energy (eV) for each point was calculated and defined as “shift amount (eV) from TiO₂, I=0.5”.

The measurement results of the Examples and the Comparative Examples are shown in Tables 1 and 2. Table 1

TABLE 1

| | | Hydrofluoric | | | Shift amount | Shift amount | 10 C/0.2 C | Capacity |
|---|---|---|---|---|---|---|---|---|
| | Electrode | acid | Stirring | Stirring | (eV) | (eV) | Discharge | maintenance |
| | to be | concentration | temperature | time | from TiO₂, | from TiO₂, | capacity | rate |
| | measured | (mass %) | (° C.) | (hr) | I = 0.2 | I = 0.5 | ratio | (%) |
| Example 1 | Negative electrode | 2 | 45 | 80 | 8.6 | 9.0 | 0.78 | 93.0 |
| Example 2 | Negative electrode | 2 | 45 | 36 | 3.1 | 3.5 | 0.83 | 96.8 |
| Example 3 | Negative electrode | 2 | 45 | 24 | 3.0 | 3.4 | 0.81 | 96.2 |
| Example 4 | Negative electrode | 2 | 45 | 1 | 1.1 | 1.2 | 0.73 | 89.2 |
| Example 5 | Negative electrode | 1 | 45 | 48 | 3.1 | 3.3 | 0.84 | 96.7 |
| Example 6 | Negative electrode | 2 | 25 | 72 | 3.5 | 3.2 | 0.82 | 96.5 |
| Example 7 | Negative electrode | 3 | 45 | 20 | 3.1 | 3.1 | 0.81 | 96.1 |
| Example 8 | Negative electrode | 4 | 45 | 10 | 3.1 | 3.4 | 0.83 | 96.8 |
| Example 9 | Negative electrode | 5 | 45 | 2 | 3.0 | 3.2 | 0.82 | 96.4 |
| Comparative | Negative electrode | — | — | — | 0.0 | 0.0 | 0.60 | 78.9 |
| Example 1 | | | | | | | | |

TABLE 2

| | | Hydrofluoric | | | Shift amount | Shift amount | 10 C/0.2 C | Capacity |
|---|---|---|---|---|---|---|---|---|
| | Electrode | acid | Stirring | Stirring | (eV) | (eV) | Discharge | maintenance |
| | to be | concentration | temperature | time | from TiO₂, | from TiO₂, | capacity | rate |
| | measured | (mass %) | (° C.) | (hr) | I = 0.2 | I = 0.5 | ratio | (%) |
| Example 10 | Positive electrode | 2 | 45 | 80 | 8.5 | 9.5 | 0.77 | 94.0 |
| Example 11 | Positive electrode | 2 | 45 | 36 | 3.1 | 3.4 | 0.82 | 96.7 |
| Example 12 | Positive electrode | 2 | 45 | 24 | 3.1 | 3.3 | 0.81 | 96.1 |
| Example 13 | Positive electrode | 2 | 45 | 1 | 1.0 | 1.2 | 0.72 | 89.2 |
| Example 14 | Positive electrode | 1 | 45 | 48 | 3.1 | 3.3 | 0.84 | 96.7 |
| Example 15 | Positive electrode | 2 | 25 | 72 | 3.5 | 3.1 | 0.81 | 96.4 |
| Example 16 | Positive electrode | 3 | 45 | 20 | 3.2 | 3.1 | 0.80 | 96.1 |
| Example 17 | Positive electrode | 4 | 45 | 10 | 3.0 | 3.5 | 0.83 | 96.3 |
| Example 18 | Positive electrode | 5 | 45 | 2 | 3.0 | 3.2 | 0.82 | 96.4 |
| Comparative | Positive electrode | — | — | — | 0.0 | 0.0 | 0.59 | 78.0 |
| Example 2 | | | | | | | | |

The capacity maintenance rate serves as an index of the cycle performance. The 10 C/0.2 C discharge capacity ratio serves as an index of the output performance.

In each of the electrodes of the Examples, the “shift amount (eV) from TiO₂, I=0.2” and the “shift amount (eV) from TiO₂, I=0.5” were positive values. That is, the first incident X-ray energy was higher than the second incident X-ray energy both when the first X-ray absorption amount was equal to the second X-ray absorption amount at 0.2 and when the first X-ray absorption amount was equal to the second X-ray absorption amount at 0.5. This is considered to be because the electrodes of the Examples each include the surface-treated LATP particles as the titanium-containing solid electrolyte. It is considered that, since the surface-treated LATP particles had a large valence, the first incident X-ray energy was higher than the second incident X-ray energy.

Although each of the electrodes of the Comparative Examples included the titanium-containing solid electrolyte in the active material-containing layer, the “shift amount (eV) from TiO₂, I=0.2” and the “shift amount (eV) from TiO₂, I=0.5” were 0. That is, the first incident X-ray energy was not higher than the second incident X-ray energy both when the first X-ray absorption amount was equal to the second X-ray absorption amount at 0.2 and when the first X-ray absorption amount was equal to the second X-ray absorption amount at 0.5. This is considered to be because the LATP particles included in the electrodes of the Comparative Examples were not subjected to surface treatment, and thus the valence of LATP did not change.

In all of the electrodes of the Examples, the 10 C/0.2 C discharge capacity ratio and the capacity maintenance rate were higher than those of the electrodes of the Comparative Examples. Therefore, it has become clear that the electrodes of the Examples are excellent in output performance and cycle performance.

In Examples 2 to 9 and 11 to 18 in which the “shift amount (eV) from TiO₂, I=0.2” and the “shift amount (eV) from TiO₂, I=0.5” were in a range of 1.0 or more and 4.0 or less, the 10 C/0.2 C discharge capacity ratio and the capacity maintenance rate were particularly high. In Examples 2, 3, 5 to 9, 11, 12 and 14 to 18 in which the “shift amount (eV) from TiO₂, I=0.2” and the “shift amount (eV) from TiO₂, I=0.5” were in a range of 3.0 or more and 3.5 or less, the 10 C/0.2 C discharge capacity ratio and the capacity maintenance rate were further high. Therefore, it has become clear that the electrodes in which the difference between the first incident X-ray energy and the second incident X-ray energy is 1 eV or more and 4 eV or less are particularly excellent in output performance and cycle performance, and that the electrodes in which the difference is 3 eV or more and 3.5 eV or less are further excellent in output performance and cycle performance.

According to at least one of the embodiments described above, an electrode is provided. The electrode includes an active material and a titanium-containing solid electrolyte. The active material includes a transition metal oxide.

In an X-ray absorption fine structure spectrum of Ti—K absorption edge for an electrode in a discharged state, a first X-ray absorption amount I at a first incident X-ray energy in a range of 4930 eV or more and 5000 eV or less satisfies 0.2≤I≤0.6, where an X-ray absorption amount at an incident X-ray energy of 5500 eV is 1.

In an X-ray absorption fine structure spectrum of Ti—K absorption edge for anatase titanium dioxide, a second X-ray absorption amount at a second incident X-ray energy in a range of 4930 eV or more and 5000 eV or less is equal to the first X-ray absorption amount I, where an X-ray absorption amount at an incident X-ray energy of 5500 eV is 1. The first incident X-ray energy is higher than the second incident X-ray energy. Therefore, the electrode can have improved cycle performance.

Hereinafter, the inventions according to the embodiments will be additionally described.

<1> An electrode including an active material and a titanium-containing solid electrolyte,
wherein the active material includes a transition metal oxide,
wherein, in an X-ray absorption fine structure spectrum of Ti—K absorption edge for the electrode in a discharged state,
a first X-ray absorption amount I at a first incident X-ray energy in a range of 4930 eV or more and 5000 eV or less satisfies 0.2≤I≤0.6, where an X-ray absorption amount at an incident X-ray energy of 5500 eV is 1,
wherein, in an X-ray absorption fine structure spectrum of Ti—K absorption edge for anatase titanium dioxide,
a second X-ray absorption amount at a second incident X-ray energy in a range of 4930 eV or more and 5000 eV or less is equal to the first X-ray absorption amount I, where an X-ray absorption amount at an incident X-ray energy of 5500 eV is 1, and
wherein the first incident X-ray energy is higher than the second incident X-ray energy.

<2> The electrode according to <1>, wherein the titanium-containing solid electrolyte includes a titanium-containing lithium phosphate composite oxide.

<3> The electrode according to <1> or <2>, wherein a difference between the first incident X-ray energy and the second incident X-ray energy is 1 eV or more and 4 eV or less.

<4> The electrode according to any one of <1> to <3>, wherein the transition metal oxide includes at least one selected from the group consisting of lithium titanate having a ramsdellite structure, lithium titanate having a spinel structure, niobium pentoxide, hollandite titanium composite oxide, orthorhombic titanium composite oxide, and monoclinic niobium titanium oxide.

<5> The electrode according to any one of <1> to <4>, wherein the transition metal oxide includes at least one selected from the group consisting of manganese dioxide, iron oxides, copper oxides, nickel oxides, lithium manganese composite oxides, lithium nickel composite oxides, lithium cobalt composite oxides, lithium nickel cobalt composite oxides, lithium manganese cobalt composite oxides, lithium manganese nickel composite oxides having a spinel structure, lithium phosphates having an olivine structure, iron sulfate, vanadium oxides, and lithium nickel cobalt manganese composite oxides.

<6> A secondary battery including:
a positive electrode;
a negative electrode; and
an electrolyte,
wherein at least one selected from the group consisting of the positive electrode and the negative electrode is the electrode according to any one of <1> to <5>.

<7> The secondary battery according to <6>, wherein the electrolyte contains a fluorine atom.

<8> A battery pack including the secondary battery according to <6> or <7>.

<9> The battery pack according to <8>, further including:
an external power distribution terminal; and
a protective circuit.

<10> The battery pack according to <8> or <9>, further including a plurality of the secondary battery, the plurality of the secondary battery being electrically connected in series, in parallel, or in a combination of in series and in parallel.

<11> A vehicle including the battery pack according to any one of <8> to <10>.

<12> The vehicle according to <11>, including a mechanism that converts kinetic energy of the vehicle into regenerative energy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising an active material and a titanium-containing solid electrolyte,
wherein the active material comprises a transition metal oxide,
wherein, in an X-ray absorption fine structure spectrum of Ti—K absorption edge for the electrode in a discharged state,
a first X-ray absorption amount I at a first incident X-ray energy in a range of 4930 eV or more and 5000 eV or less satisfies 0.2≤I≤0.6, where an X-ray absorption amount at an incident X-ray energy of 5500 eV is 1,
wherein, in an X-ray absorption fine structure spectrum of Ti—K absorption edge for anatase titanium dioxide,
a second X-ray absorption amount at a second incident X-ray energy in a range of 4930 eV or more and 5000 eV or less is equal to the first X-ray absorption amount I, where an X-ray absorption amount at an incident X-ray energy of 5500 eV is 1, and
wherein the first incident X-ray energy is higher than the second incident X-ray energy.

2. The electrode according to claim 1, wherein the titanium-containing solid electrolyte comprises a titanium-containing lithium phosphate composite oxide.

3. The electrode according to claim 1, wherein a difference between the first incident X-ray energy and the second incident X-ray energy is 1 eV or more and 4 eV or less.

4. The electrode according to claim 1, wherein the transition metal oxide comprises at least one selected from the group consisting of lithium titanate having a ramsdellite structure, lithium titanate having a spinel structure, niobium pentoxide, hollandite titanium composite oxide, orthorhombic titanium composite oxide, and monoclinic niobium titanium oxide.

5. The electrode according to claim 1, wherein the transition metal oxide comprises at least one selected from the group consisting of manganese dioxide, iron oxides, copper oxides, nickel oxides, lithium manganese composite oxides, lithium nickel composite oxides, lithium cobalt composite oxides, lithium nickel cobalt composite oxides, lithium manganese cobalt composite oxides, lithium manganese nickel composite oxides having a spinel structure, lithium phosphates having an olivine structure, iron sulfate, vanadium oxides, and lithium nickel cobalt manganese composite oxides.

6. A secondary battery comprising:
a positive electrode;
a negative electrode; and
an electrolyte,
wherein at least one selected from the group consisting of the positive electrode and the negative electrode is the electrode according to claim 1.

7. The secondary battery according to claim 6, wherein the electrolyte contains a fluorine atom.

8. A battery pack comprising the secondary battery according to claim 6.

9. The battery pack according to claim 8, further comprising:
an external power distribution terminal; and
a protective circuit.

10. The battery pack according to claim 8, further comprising a plurality of the secondary battery, the plurality of the secondary battery being electrically connected in series, in parallel, or in a combination of in series and in parallel.

11. A vehicle comprising the battery pack according to claim 8.

12. The vehicle according to claim 11, comprising a mechanism that converts kinetic energy of the vehicle into regenerative energy.
